(19) United States
(12) Patent Application Publication
(10) Pub. No.: US 2002/0196816 A1
(43) Pub. Date: Dec. 26, 2002

(54) Wavelength tunable pulse laser

(76) Inventor: Masataka Shirasaki, Winchester, MA (US)

Correspondence Address: CORLUX CORPORATION, 47361 BAYSIDE PARKWAY, FREMONT, CA, 94538, US

(21) Appl. No.: 09/998,289

(22) Filed: Nov. 30, 2001

Related U.S. Application Data
(60) Provisional application No. 60/300,244, filed on Jun. 22, 2001.

(51) Int. Cl. H01S 3/10

(52) U.S. Cl. 372/20

(57) ABSTRACT

In one embodiment, the invention relates to a tunable laser system. The laser system includes a first optical path at a first wavelength having a first path length and a second optical path at a second wavelength having a second path length. The first and second optical paths partially overlap in a shared path region that is shorter than either the first or second path lengths. The first and second path lengths are substantially equal. The laser system also includes an optical modulator that is located within the shared path. The laser system selects a wavelength of an optical pulse according to a sequence of drive signals from the drive signal generator. In another embodiment the laser system additionally includes a Fabry-Perot filter located in one of the shared paths. In operation of this embodiment, the laser system generates a series of optical pulses of different wavelengths.

### RELATED APPLICATIONS

This application claims priority to U.S. Provisional Patent Application Serial No. 60/300,244, filed on Jun. 22, 2001.

### FIELD OF THE INVENTION

This invention relates generally to optical devices, and more specifically to wavelength tunable lasers and multi-wavelength lasers.

### BACKGROUND OF THE INVENTION

The demand for increased communication data rates necessitates a constant need for improved technologies to support that demand. One such emerging technology area is in fiber-optic communications, in which data is transmitted as light energy over optical fibers. To increase data rates, more than one data channel can exist on a single fiber link. For example, in wavelength division multiplexing (“WDM”), different channels are differentiated by wavelength. This differentiation requires special optical components to produce the light energy at each of the wavelengths that correspond to the different channels. In WDM systems, one technique is based on the design of lasers according to different parameters for each of the channel specific wavelengths. This technique has the disadvantage that each laser can only be used for one channel. This lack of interoperability increases the cost and complexity of designing, manufacturing, and maintaining WDM systems.

Another technique is based on the design of lasers that are capable of producing light over a range of wavelengths. Such tunable lasers can utilize a distributed feedback (DFB) laser design or distributed Bragg reflector (DBR) laser design. A DFB laser system requires a specific refractive index of the semiconductor laser material and a periodic grating within or adjacent to the gain layer of the laser to reflect only specific wavelengths of light. This wavelength selective reflection is the basis for a feedback mechanism that ensures certain longitudinal modes in the optical cavity resonate at a higher power than other longitudinal modes. Light energy from a DFB laser system has the advantage that it is confined to a narrow wavelength, or frequency, band.

DBR laser systems are similar to DFB laser systems except that the periodic grating is located at the ends of the optical cavity instead of inside the gain region. Various techniques are used to tune DFB and DBR laser systems to resonate at different wavelengths. One technique includes applying an electric current to alter the refractive index of the laser cavity. However, as the refractive index of the material can not be significantly varied, the tuning range and the output power of these systems are limited.

Another technique for tuning laser systems is based on providing optical cavities of different lengths for different wavelengths. One such a prior art system is shown in FIG. 1. The mode locked laser system 2 includes a reflector 4, an optical modulator 8, a drive signal generator 12, a gain element 16 and a chirped Bragg fiber grating 20. As shown in FIG. 1, the reflector 4 in one embodiment is immediately adjacent to the optical modulator 8.

In general, a chirped Bragg fiber grating is an optical fiber grating that substantially reflects a single wavelength at a given position along the fiber. Different wavelengths are reflected at different positions in the fiber. The effect is based on the changing periodicity of refractive index variations along the fiber. As depicted in FIG. 4 and as referred to throughout the following description, a fiber grating 20 can be a negative fiber grating 58, or, as depicted in FIG. 5, a positive fiber grating 62. As defined from the perspective of the incident light, negative fiber grating 58 starts with a broad grating spacing 59 and progresses to a narrow grating spacing 61. A positive fiber grating 62 is constructed in the opposite fashion. In operation, an optical signal 54 is focused into the negative 58 or positive 62 fiber gratings by a lens 66. Longer wavelengths are reflected first from the negative fiber grating 58 and shorter wavelengths are reflected last. Similarly, shorter wavelengths are reflected first from the positive fiber grating 62 and longer wavelengths are reflected last.

Referring again to the mode locked laser system 2 of FIG. 1, the optical cavity 24 for a longer wavelength pulse 34 and the optical cavity 30 for a shorter wavelength pulse 34′ are shown. The optical cavity is the region in which a reflected optical pulse repeatedly travels. As shown, the fiber grating 20 operates as a negative fiber grating 58. Hence, the length of the optical cavity 24 for a longer wavelength pulse is less than the length of the optical cavity 30 for a shorter wavelength pulse because longer wavelength pulses are reflected from the left side of the fiber grating 20 while shorter wavelength pulses are reflected from the right side of the fiber grating 20.

This variation in the size of the optical cavity means that the repetition frequency with which an optical pulse passes through the optical modulator 8 is dependent on wavelength. Referring to FIG. 2, timing diagrams 46, 50 for the longer wavelength pulse 34 and the shorter wavelength pulse 34′, respectively, are shown. The timing diagrams 46, 50 contain sequences of drive signals 38, 42 and 38′, 42′. The correspondence between these drive signals 38, 42, 38′, 42′ and the long wavelength 34 and the short wavelength 34′ optical pulse propagating in its respective optical cavity 24, 30 is shown in the operational flow chart FIG. 3. For clarity of presentation, FIG. 3 shows only the modulators 8, 8′, the reflectors 4, 4′ optical pulses 34, 34′, and optical cavities 24, 30.

Referring to FIGS. 2 and 3, at time t₁, the optical pulses 34, 34′ are shown when the drive signals 38, 38′ actuate the modulators 8, 8′ making them transparent, thereby allowing the pulses 34, 34′ to enter. In operation the optical modulator 8 can considered to be a shutter that is generally opaque and that only allows pulses to pass when it is made transparent by a drive signal. The modulators 8, 8′ remain transparent while the drive signals 38, 38′ are asserted, that is, until time t₂ when the pulses 34, 34′ exit the modulators 8, 8′. During the period from time t₁ until time t₂, the pulses 34, 34′ are reflected by the reflector 4. At time t₃, the optical pulse 34 has returned to the modulator 8 that the drive signal 42 again makes transparent. The modulator 8′ remains opaque because the shorter wavelength optical pulse 34′ is traveling in a larger optical cavity. Hence, its return drive signal pulse 42′ does not occur until later. At time t₄, the modulator in the optical cavity 24 becomes opaque again coinciding with the exit of the pulse 34 from the modulator 8. At this time t₄, the pulse 34′ is still continuing on its return trip to the modulator 8′. At time t₅, the assertion of the drive signal 42′ is completed and the modulator 8′ returns to an opaque state. At this time t₅, the pulse 34′ has just exited the modulator 8′ thereby completing one oscillation.

A comparison of the pulses 34, 34′ at the times shown in FIG. 3 illustrates at least two points regarding the laser system 2. First, an optical pulse can only survive with a sequence of drive signals 38, 42 or 38′, 42′ that corresponds to its passage through the modulator, and second, the repetition rate for a long wavelength pulse 34 and a short wavelength pulse 34′ are not equal. The repetition rate for the long wavelength pulse 34 is given by the time between times t₂ and t4. The repetition rate for the short wavelength pulse 34′ is given by the time between times t₂ and t₅.

These different round trip times have the disadvantage that the output pulse repetition rate for the laser system 2 varies according to the wavelength. The bit rate of a WDM system based on the laser system 2 is generally either equal to or an integer multiple of the repetition rate. Because WDM systems require a constant bit rate, the variation in repetition rate with wavelength for the laser system 2 makes it impractical as a tunable laser for WDM systems.

What is needed is a wavelength tunable pulse laser that overcomes these disadvantages of current tunable pulse lasers.

### SUMMARY OF THE INVENTION

The wavelength tunable laser of the present invention is non-mechanical and has a wide-tuning range. The wavelength tunable laser selects an operating wavelength by varying the period between drive signals without the need to change the output pulse repetition rate. This feature of the invention is achieved by providing spatially distinct optical cavities. These optical cavities are of equal length for all wavelengths.

In one embodiment, the invention relates to a tunable laser system. The laser system includes a first optical path at a first wavelength having a first path length and a second optical path at a second wavelength having a second path length. The first and second optical paths partially overlap in a shared path region that is shorter than either the first or second path lengths. The first and second path lengths are substantially equal. The laser system also includes an optical modulator that is located within the shared path. In another embodiment the laser system further includes a drive signal generator that is in electrical communication with the optical modulator. In operation, the laser system selects a wavelength of an optical pulse according to a sequence of drive signals from the drive signal generator. In a further embodiment, the wavelength is varied by changing the period between drive signals.

In an additional embodiment, the laser system also includes a gain element that is located in the shared path region. In a further additional embodiment, the functional aspects of the optical modulator and the gain element are combined in a single gain modulator element. In yet another embodiment, the optical modulator of the laser system is a traveling wave modulator. In another embodiment, the laser system also includes a Fabry-Perot filter disposed in the shared path. In an additional embodiment, the Fabry-Perot filter disposed in the shared path increases the temporal duration of optical pulses generated by the system. In another embodiment, the free spectral range of the Fabry-Perot filter is chosen to match the channel spacing of an attached wavelength division multiplexing system.

In yet an additional embodiment, the laser system also includes a dispersion correction element optically coupled the first and second optical paths. The dispersion correction element shortens the temporal duration of optical pulses generated by the system. In yet a further embodiment, the laser system also includes a plurality of optical beam couplers optically coupled to the first and second optical paths. The plurality of optical beam couplers generate a plurality of optical pulses from a single input optical pulse. In another embodiment, the laser system also includes a Fabry-Perot filter optically coupled to the first and second optical paths. The Fabry-Perot filter optically coupled to the first and second optical paths generates a plurality of optical pulses from a single input optical pulse. In an additional embodiment, the laser system also includes an external modulator optically coupled to an optical communications network. The external modulator modulates optical pulses onto the optical communications network.

In one embodiment, the laser system includes a first fiber grating and a second fiber grating. These fiber gratings define a plurality of optical cavities for a plurality of respective wavelengths. Each optical cavity is substantially the same length and partially overlaps the other optical cavities in a shared path region. The shared path region is shorter than each of the optical cavities. The laser system also includes an optical modulator located in the shared path region asymmetrically with respect to the first and second fiber gratings.

In another embodiment, the near end of the first fiber grating is farther from the optical modulator than the far end of the second fiber grating. In an additional embodiment, the laser system also includes a reflector and the first fiber grating is at least partially adjacent to the second fiber grating.

In one embodiment, the laser system includes a first fiber grating and a second fiber grating. At least one of these gratings have a plurality of grating regions. Each grating region has a unique grating period. Each of the plurality of grating regions defines an optical cavity for a respective wavelength. Each optical cavity is substantially the same length and overlaps the other optical cavities in a shared path region. The shared path region is shorter than each of the optical cavities. The laser system also includes an optical modulator located in the shared path region. In a further embodiment, the optical modulator is located asymmetrically with respect to the first and second fiber gratings.

In one embodiment, the laser system includes a first fiber grating and a second fiber grating. These fiber gratings define a plurality of optical paths for a plurality of respective wavelengths. Each optical path is substantially the same length and overlaps the other optical paths in a first and a second shared path region. The combined length of the first and second shared path regions is shorter than the length of each of the optical paths for each respective wavelength. The laser system also include first and second optical modulator regions located, respectively, in the first and second shared path regions. In a further embodiment, the first and second optical modulator regions are asymmetrically located with respect to the first and second fiber gratings. In an additional embodiment, an optical pulse propagating in the laser system is constrained to travel from the first optical modulator region to the first fiber grating and from the second optical modulator region to the second fiber grating. In another embodiment, the laser system also includes a Fabry-Perot filter disposed in the first shared path region. In an additional embodiment, the Fabry-Perot filter disposed in the first shared path region increases the temporal duration of optical pulses generated by the system. In an additional embodiment, the free spectral range of the Fabry-Perot filter is chosen to match the channel spacing of an attached wavelength division multiplexing system. In a further embodiment, at least one of the fiber gratings is a chirped fiber grating. In still another embodiment, at least one of the fiber gratings has a plurality of grating regions wherein each grating region has a unique grating period.

In still another embodiment, the laser system includes a polarization dependent beam director and a quarter wave plate located in the plurality of optical paths. In yet another embodiment, the polarization dependent beam director includes a polarizing beam splitter. In a still further embodiment, the polarization dependent beam director includes a birefringent crystal plate. In a yet further embodiment, the polarization dependent beam director includes a birefringence crystal wedge. In a still additional embodiment, the laser system includes first and second drive signal generators that are in electrical communication, respectively, with the first and second optical modulator regions. In operation, this embodiment of the laser system selects the wavelength of an optical pulse according to a sequence of drive signals from the drive signal generators. In a yet a further embodiment, the wavelength is varied by changing the period between drive signals. In still another embodiment also including first and second drive signal generators, a series of optical pulses are generated in response to a sequence of drive signals from the first and second drive signal generators. In still an additional embodiment, the sequence of drive signals have non-uniform amplitude.

In a further embodiment, the laser system also includes a first gain element located in the first shared path region. In an additional embodiment, the functional aspects of the first optical modulator region and the first gain element are combined in a first gain modulator element. In a yet further embodiment, the first optical modulator region is a traveling wave modulator region.

In a still further embodiment, the laser system also includes a circulator located in the plurality of optical cavities. In a yet additional embodiment, the circulator includes a polarizing beam splitter, a faraday rotator, and a polarizer. In a still additional embodiment, the circulator includes a birefringent crystal plate, a faraday rotator, and a polarizer. In another embodiment, the circulator includes a birefringent crystal wedge, a faraday rotator, and a polarizer.

In an additional embodiment, the near end of the first fiber grating is farther from the first and second optical modulator regions than the far end of the second fiber grating.

In a further embodiment, the laser system also includes a dispersion correction element optically coupled to the plurality of optical paths. The dispersion correction element shortens the temporal duration of optical pulses generated by the system.

In yet a further embodiment, the laser system includes a plurality of optical beam couplers optically coupled to the plurality of optical paths. The plurality of optical beam couplers generate a plurality of optical pulses from a single input optical pulse. In another embodiment, the laser system includes a Fabry-Perot filter optically coupled to the plurality of optical paths. The Fabry-Perot filter optically coupled to the the plurality of optical paths generates a plurality of optical pulses from a single input optical pulse. In another embodiment, the system includes an external modulator optically coupled to an optical communications network. In this embodiment, the external modulator modulates optical pulses onto the optical communications network.

In one embodiment, the laser system includes a first fiber grating and a second fiber grating that define a plurality of optical paths for a plurality of respective wavelengths. Each of the plurality of optical paths overlaps the other of the plurality of optical paths in a first shared path region and in a second shared path region. Each of the plurality of optical paths have substantially the same length. The combined length of the first and second shared paths is shorter than the length of each of the plurality of optical paths. The laser system also includes an optical modulator located asymmetrically in the first shared path with respect to the first and second fiber gratings. The laser system also includes a gain element located asymmetrically in the first shared path with respect to the first and second fiber gratings. The laser system additionally includes a Fabry-Perot filter located in one of the first and second shared paths. The laser system further includes a drive signal generator in electrical communication with the optical modulator. In operation, the laser system generates a series of optical pulses of different wavelengths by the optical modulator and the Fabry-Perot filter in response to a sequence of drive signals from the drive signal generators.

### BRIEF DESCRIPTION OF THE DRAWINGS

The above and further advantages of the invention may be better understood by referring to the following description taken in conjunction with the accompanying drawings, in which:

FIG. 1 is a laser system as known to the prior art;

FIG. 2 is timing diagram for the laser system of FIG. 1 as known to the prior art;

FIG. 3 is a timing flow chart illustrating the operation of the laser system of FIG. 1 as known to the prior art;

FIG. 4 is a graphical representation of the operation of a negative fiber grating;

FIG. 5 is a graphical representation of the operation of a positive fiber grating;

FIG. 6 is block diagram of a laser system employing negative and positive fiber gratings according to the invention;

FIG. 7 is an embodiment of a fiber grating according to the invention;

FIG. 8 is a graphical representation of modulator drive signals for the laser system of FIG. 6;

FIG. 9 is block diagram of a laser system employing a Fabry-Perot filter;

FIG. 10 is a schematic representation of optical pulses produced by the laser system of FIG. 9;

FIG. 11 depicts a step fiber grating;

FIG. 12 is a schematic representation of optical pulses produced by the step fiber grating of FIG. 11;

FIG. 13 is a plot of delay versus wavelength for optical pulses incident at the 166a end of the step fiber grating of FIG. 11;

FIG. 14 is block diagram of a diffraction grating and a mirror array;

FIG. 15 is a block diagram of a laser system employing a single fiber grating;

FIG. 16 is schematic representation of a dual-core fiber used in an alternative embodiment of the laser system shown in FIG. 15;

FIG. 17 is a block diagram of two fiber gratings used in an alternative embodiment of the laser system shown in FIG. 15;

FIG. 18 is a block diagram of a compact laser system according to the invention;

FIG. 19 is block diagram of a laser system employing a traveling wave modulator according to the invention;

FIG. 20 is a depiction of the traveling wave modulator of the laser system of FIG. 19 in more detail;

FIGS. 21A and 21B are graphical representations of drive signals for the laser system of FIG. 19;

FIG. 22 is a block diagram of an embodiment of a laser system according to the invention;

FIGS. 23A and 23B are graphical representations of drive signals for the laser system of FIG. 22;

FIG. 24 is a schematic an embodiment of one side of the laser system of FIG. 22, including a polarizing beam splitter as part of the polarization dependent beam directors;

FIG. 25 is a schematic view of an another embodiment of one side of the laser system of FIG. 22, including a birefringent crystal plate as part of the polarization dependent beam directors;

FIG. 26 is a schematic view of another embodiment of one side of the laser system of FIG. 22 including a birefringent crystal wedge as part of the polarization dependent beam directors;

FIG. 27A is a block diagram of an embodiment of a laser system employing circulators according to the invention;

FIG. 27B is a block diagram of another laser system employing circulators according to the invention;

FIGS. 28A and 28B are graphical representations of the drive signals for the laser system of FIG. 27;

FIG. 29 is a schematic view of an embodiment of one side of the laser system of FIG. 27 utilizing a polarizing beam splitter as part of the circulators;

FIG. 30 is a schematic view of an embodiment of one side of the laser system of FIG. 27 utilizing a birefringent crystal plate as part of the circulators;

FIG. 31 is a schematic view of an embodiment of one side of the laser system of FIG. 27 utilizing a birefringent crystal wedge as part of the circulators;

FIG. 32 is a block diagram of a laser system that simultaneously produces multiple optical pulses of different wavelengths according to the invention;

FIG. 33 is a schematic representation of a series of optical pulses generated by the laser system of FIG. 32;

FIG. 34 is a schematic representation of drive signals used in the laser system shown in FIG. 32;

FIG. 35 is a schematic representation of a series of non-uniform drive signals used in an embodiment of the laser system shown in FIG. 32;

FIG. 36 is a block diagram of an alternative embodiment of a laser system that simultaneously produces multiple optical pulses of different wavelengths according to the invention;

FIG. 37 is a schematic representation of a waveform applied to the gain element of the laser system of FIG. 36;

FIGS. 38A and 38B are block diagrams of laser systems having mechanisms for extracting optical energy according to the invention;

FIG. 39A is a block diagram illustrating a laser system including an external modulator for modulating light in accordance with the invention;

FIG. 39B is a block diagram illustrating a delay line system according to the invention;

FIG. 40 is a schematic representation of a Fabry-Perot filter used in accordance with the invention to generate multiple output pulses from a single input pulse; and

FIG. 41 is a block diagram illustrating use of a chromatic dispersion correction element in combination with a laser system in accordance with the invention.

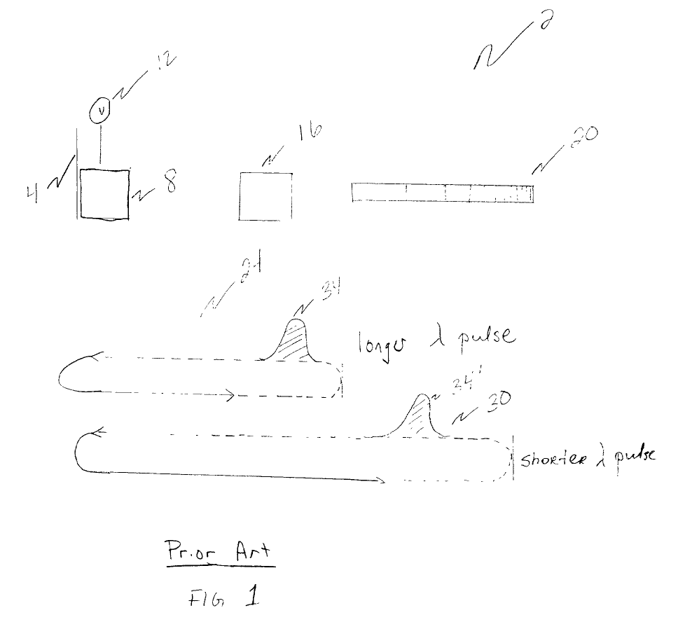

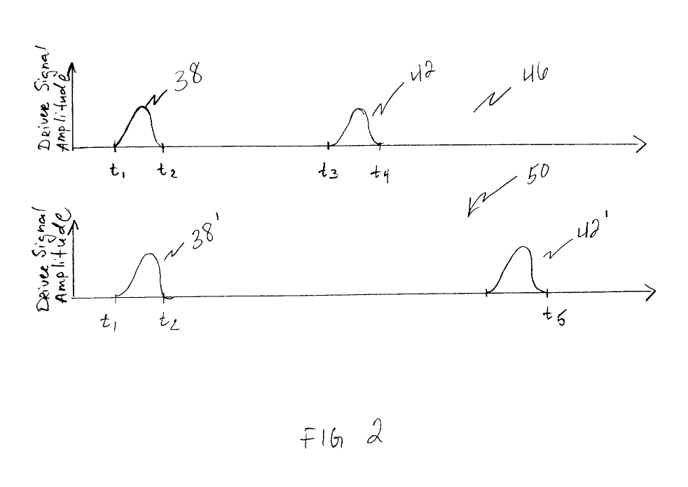

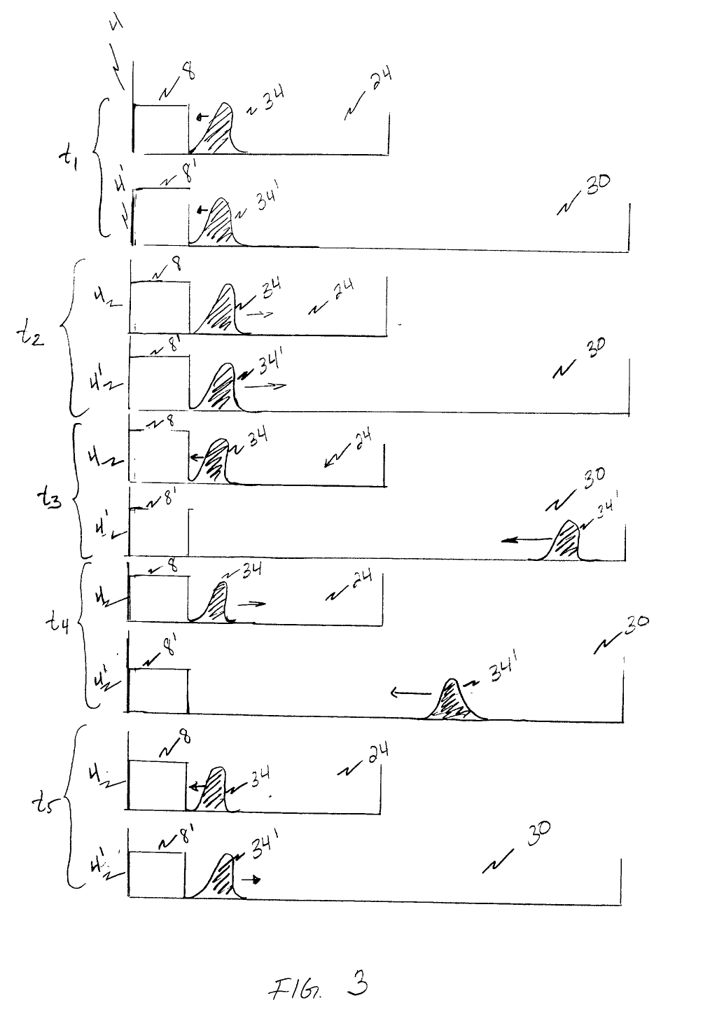

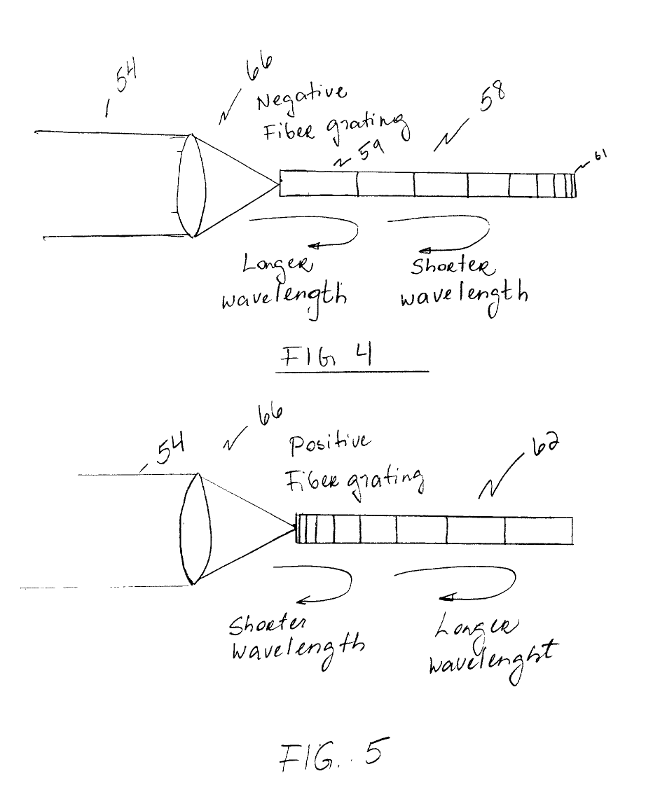

### DETAILED DESCRIPTION

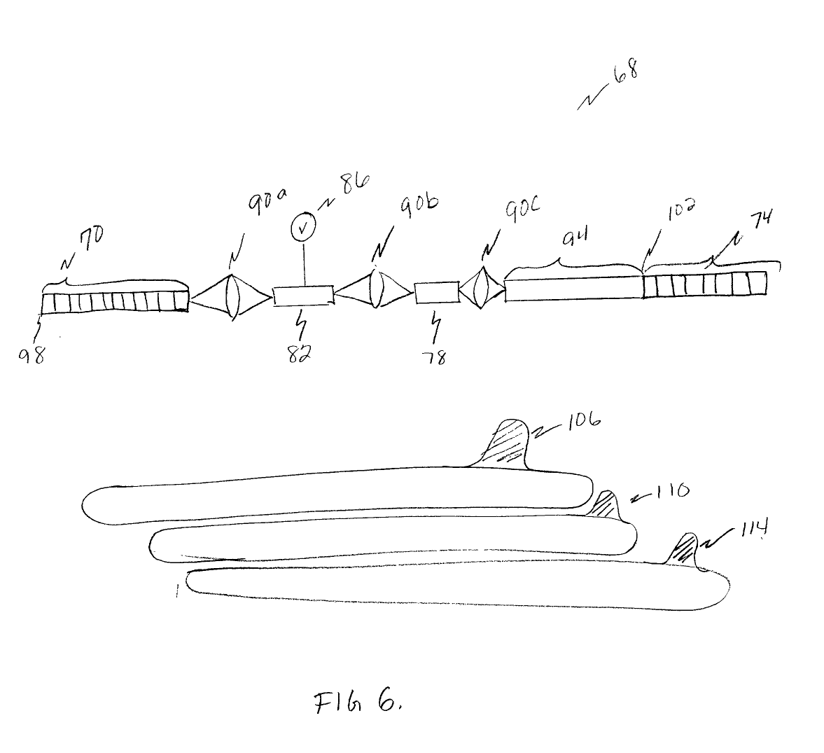

FIG. 6 shows a laser system 68 including a negative fiber grating 70 and a positive fiber grating 74. The negative and positive fiber gratings, 70 and 74, respectively, have equal but opposite grating spacings. The laser system 68 also includes a gain element 78, an optical modulator 82, and a drive signal generator 86. Although shown with a gain element 78 and an optical modulator 82, an alternative embodiment for the laser system 68, described below, replaces these elements with a gain/modulator 80. The optical modulator 82 can be any modulator known to those of skill in the art, such as a lithium niobate electro-optic modulator.

In one embodiment of the laser system 68, the common absolute value of the grating spacings of the fiber gratings 70, 74 is ensured by introducing the periodic disturbances into the fibers gratings 70, 74 at the same time during their manufacture. So that the two simultaneously manufactured fiber gratings 70, 74 have opposite grating values, their orientation relative to each other is reversed when the laser system 68 is assembled. That is, one of the fiber gratings is oriented as negative fiber grating 70 and the other is oriented as a positive fiber grating 74.

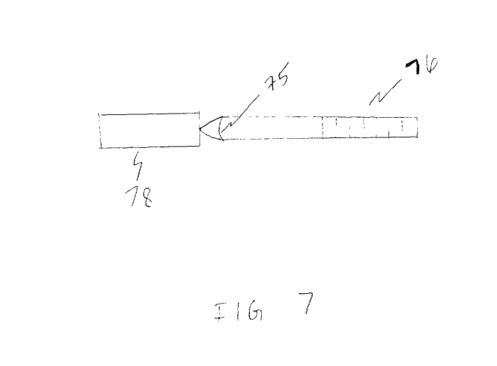

Light energy is transmitted between the negative fiber grating 70 and the optical modulator 82 through a first lens 90a, between the optical modulator 82 and the gain element 78 through a second lens 90b, and between the gain element 78 and a fiber offset 94 through a third lens 90c. In an alternative embodiment, the light energy is coupled from the fiber grating into the optical modulator 82 or the gain element 78 by a fiber grating 76 that has a curved end surface 75, as shown in FIG. 7, that functions as a lens to focus the light energy into the respective optical element. The fiber offset 94 can be an optical fiber in which there is no index variation in the core. Alternatively, the fiber offset 94 and the positive fiber grating 74 can be integrated as a single optical fiber having a variation in refractive index only in a portion of the fiber core.

In the laser system 68, the negative fiber grating 70 and the positive fiber grating 74 are asymmetrically located with respect to the optical modulator 82. As discussed below, this asymmetry allows for different sequences of drive signals to uniquely select a particular wavelength. In particular, according to the asymmetric design, the far end 98 of the negative fiber grating 70 is at least as close to the optical modulator 82 as the near end 102 of the positive fiber grating 74. The length of the fiber offset 94 is chosen to ensure this design criterion. The range of optical cavities created by this asymmetric design is depicted by the optical cavities for the shortest supported wavelength pulse 106, an intermediate supported wavelength pulse 110, and the longest supported wavelength pulse 114. As the negative 70 and positive 74 fiber gratings have the same length, equal but opposite grating spacings and opposite orientations, the optical cavity for all supported wavelengths are equal. Thus, the round trip time is the same for all supported wavelengths.

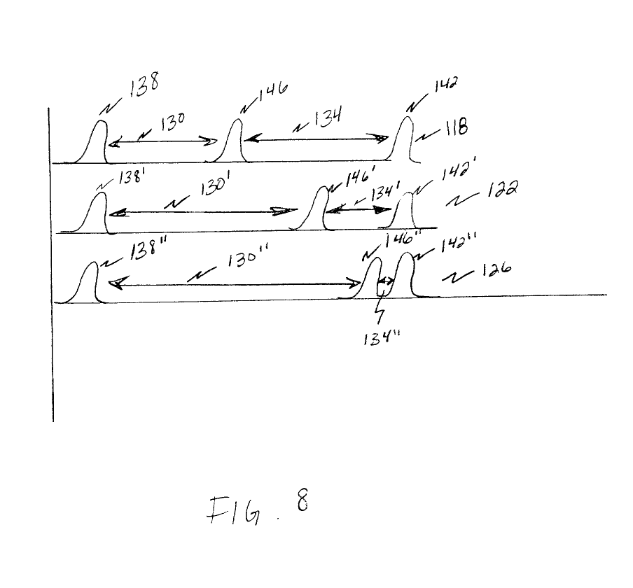

The asymmetric design described above combined with the common lengths of the optical cavities ensures that each supported wavelength is uniquely generated by a particular sequence of drive signals. The timing diagrams for the shortest wavelength pulse 118, an intermediate wavelength pulse 122, and the longest wavelength pulse 126 are shown in FIG. 8. Each timing profile is unique to a particular wavelength because the ratio of the return time period 130, 130′, 130″ from the optical modulator 82 through the positive fiber grating 74 to the return time 134, 134′, 134″ period from the modulator 82 through the negative fiber grating 70 is unique for each wavelength. More explicitly, no pair of wavelength pulses shares a period ratio or a sequence of drive signals due to two factors: 1) the return time period through the positive fiber grating 74 is quickest for the shortest wavelength pulse and 2) this return time period is at least one half of the round trip time period. This latter factor is the result of two previously mentioned factors: 1) that the near end 102 of the positive fiber grating 74 is at least as far as the far end 98 of the negative fiber grating 70, and 2) that the negative fiber grating 70 and the positive fiber grating 74 have a common length and grating spacing.

As the round trip time for pulses of all wavelengths is the same, the first 138, 138′, 138″ are coincident and third 142, 142′, 142″ drive signals are coincident. Thus, the repetition rate is constant for all supported wavelengths. However, as mentioned above, the sequence of drive signals is unique for each supported wavelength. In particular, the intermediate drive signals 146, 146′, 146″ (generally 146) move to the right as wavelength increases. Therefore, because the middle drive signal 146 always occurs at least half way through a round trip from the optical modulator 82, only a single wavelength is selected for each unique sequence of drive signals. In one embodiment, when the sequence of drive signals is changed in order to tune the laser system 68 to a new wavelength, the gain element 78 or the modulator 82 is turned off during the transition period to extinguish the previous wavelength optical pulses and to facilitate the generation of the new wavelength optical pulses.

Although the discussion above pertains to the structure described in FIG. 6, the positive and negative fiber gratings 74, 70 can be interchanged, in this and later embodiments, without changing the operating principles of the invention. This exchange would interchange the selection of the longest and shortest wavelength pulses by the timing profiles 126 and 118, respectively.

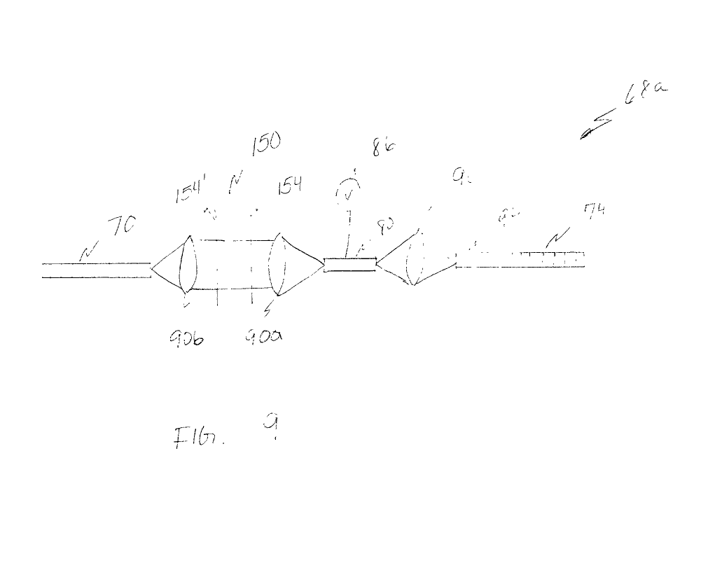

FIG. 9 shows a laser system 68a that includes a negative fiber grating 70, a positive fiber grating 74, a gain/modulator 80, a drive signal generator 86, a fiber offset 94, three lens 90a, 90b, 90c, and a Fabry-Perot filter 150. FIG. 10 shows the change in operational characteristics introduced by the Fabry-Perot filter 150. In particular without the Fabry-Perot filter 150, a laser system, such as the laser system 68 produces optical pulses that have a relatively broad wavelength spectral spread 158, and thus a narrow temporal distribution, typically on the order of a nanosecond. The initial source of the broad spectral spread 162 is due to gain mediums 78, 80 that typically excite wavelengths over a broad range. In the laser systems 68, 68a this spectral range is narrowed by the wavelength selection procedures described above with respect to FIG. 8. In the laser system 68a, a further narrowed spectral spread 162 is achieved by the introduction of the Fabry-Perot filter 150. The pulses corresponding to this narrow spectral spread 162 typically have a temporal duration on the order of 20 to 50 nanoseconds.

The Fabry-Perot filter 150 consists of two facing reflective surfaces 154, 154′ that are placed in the collimated optical path between the lenses 90a and 90b. In one embodiment, the reflective surfaces 154, 154′ are placed on either side of a glass block. In another embodiment, the reflective surfaces are placed on the inner sides of two glass plates. In general, the Fabry-Perot filter 150 can be any Fabry-Perot filter known to those of skill in the art.

The reflective surfaces 154, 154′ reflect on the order of 90 percent of the incident light energy. Thus, the majority of light energy resonates between the reflective surfaces 154, 154′ for multiple return trips. All wavelengths except for those equal to twice the distance between the reflective surfaces 154, 154′ divided by an integer experience destructive interference. In operation, light energy accumulates between the reflective surfaces 154, 154′ until the amount of incident light energy is equal to the amount of transmitted light energy. The transmission profile of the laser system 68a has distinct peaks 162, 162a, 162b, 162c, 162d at those wavelengths. In one embodiment these wavelengths are chosen to correspond, respectively, to the wavelengths of the channels of a WDM system.

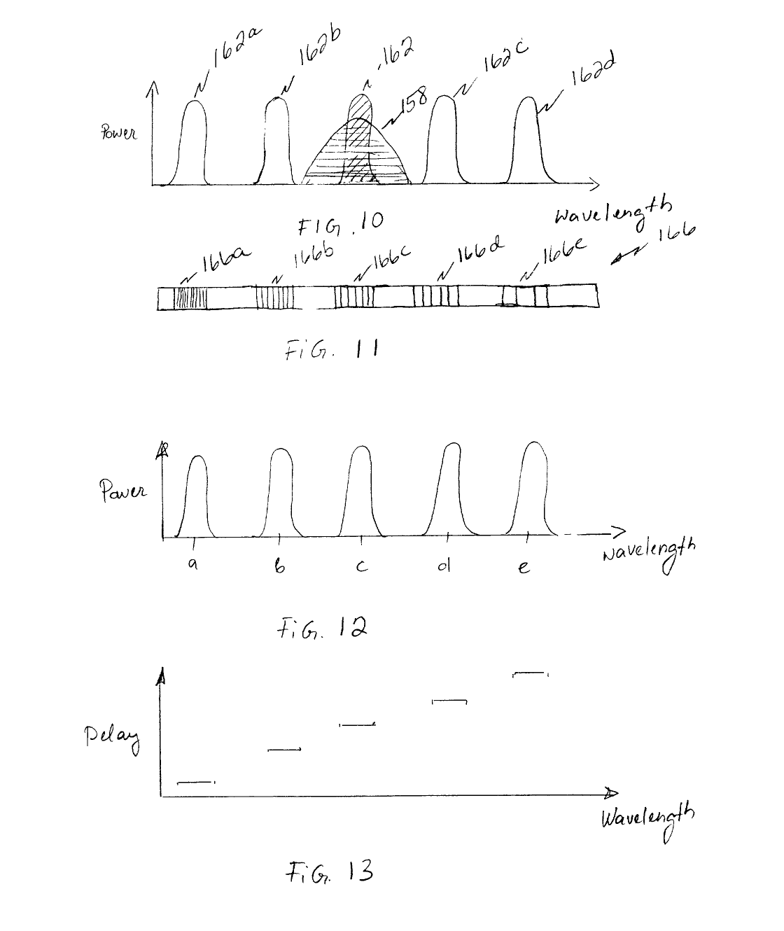

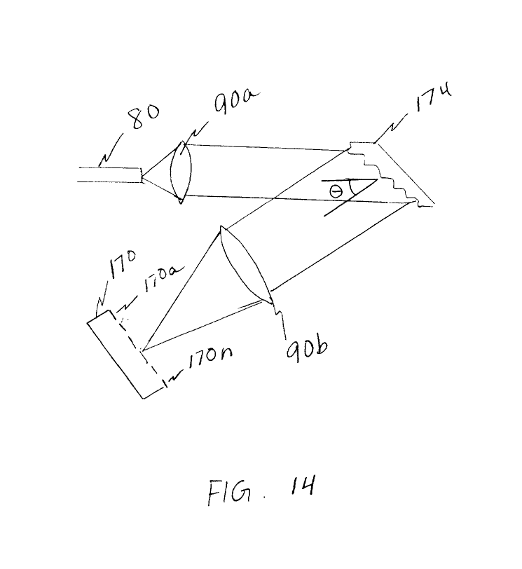

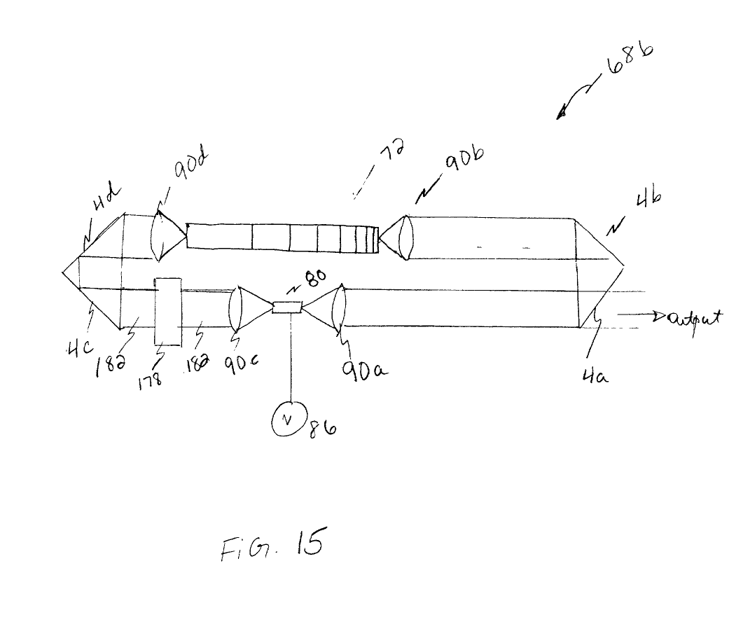

The narrow spectrum of generated optical pulses shown in FIG. 10 is achieved without a Fabry-Perot filter 150 in another embodiment of the laser system 68 in which at least one of the negative fiber grating 70 and the positive fiber grating 74 are each replaced with a step fiber grating 166, as shown in FIG. 11. The step fiber grating 166 has a series of regions 166a, 166b, 166c, 166d, 166e of unique grating spacings. As each region 166a, 166b, 166c, 166d, 166e only reflects a single wavelength, the reflection spectrum of the step fiber grating 166 has distinct corresponding peaks as shown in FIG. 12. FIG. 13 shows the delay relative to wavelength for the step fiber grating 166 for optical pulses that are incident from the left. As the step fiber grating 166 starts with a narrow grating spacing 166a and monotonically progresses to a broader grating spacing 166e, shorter optical pulses are reflected first and delayed the least while longer optical pulses are reflected last and delayed the most.

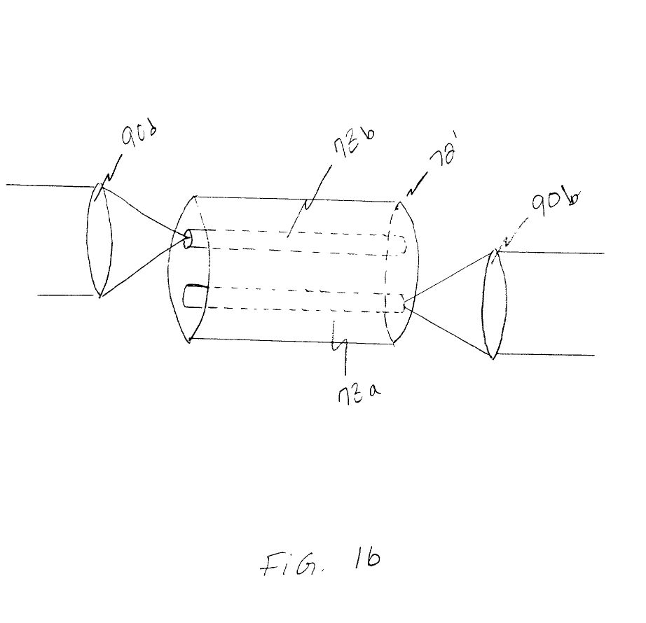

The compact spectral distribution of generated optical pulses shown in FIG. 10 is also achieved in an embodiment of the laser system 68 in which the fiber gratings 70, 74 are each replaced with a diffraction grating 174 and a mirror array 170, as shown in FIG. 14. The mirror array 170 consists of a series of mirrors 170a, . . . ,170n that are separated by non-reflective regions. In operation, light that exists the right of the gain/modulator 80 is collimated by a lens 90a and is directed to the diffraction grating 174. The diffraction grating 174 reflects each wavelength in the incident light at a slightly different angle θ. The reflected light is focused by a lens 90b onto the mirror array 170. The diffraction grating 174 and the mirror array 170 are oriented so that shortest supported wavelength and the longest supported wavelength are each reflected, respectively, by the mirrors 170a, 170n at opposite ends of the mirror array 170. In addition, the diffraction grating 174 and the mirror array 170 are oriented so that the optical path is shortest for light reflected from 170a and is longest for light reflected from 170n. In particular, light reflected from 170a is directed towards the upper portion of the diffraction grating 174 while light reflected from 170n is directed towards the lower portion of the diffraction grating 174. For example, consider that the diffraction grating 174 and the mirror array 170 replace the positive fiber grating 74 in the laser system 68. In this case, the shortest wavelength optical pulses are reflected from the mirror 170a and the longest wavelength optical pulses are reflected from the mirror 170n. The diffraction grating 174 and mirror array 170 that replaced the negative fiber grating 70 would operate in the opposite fashion. In addition, the diffraction gratings 174 and mirror arrays 170 are asymmetrically located as described above so that the wavelength of generated optical pulses can be selected by varying the sequence of drive signals.

The reflection profile produced by the diffraction grating 174 and the mirror array 170 is similar to the series of peaks shown in FIG. 12. The series of peaks occurs because optical pulses are reflected only if their wavelength corresponds to a wavelength that is focused on one of the mirrors 170a, . . . , 170n in the mirror array 170. The relatively narrow spectral spread of the peaks, similar to 162, occurs because the width of the spectrum of the reflected pulses is controlled in part by the width of the mirrors 170a, . . . , 170n, which are selected to be relatively narrow.

FIG. 15 shows an alternative embodiment 68b of the present invention that uses only one fiber grating 72 and is compact in design. The laser system 68b includes a gain/modulator 80, a drive signal generator 86, four reflectors 4a, 4b, 4c, 4d, four lenses 90a, 90b, 90c, 90d, a fiber grating 72, and a path length adjuster 178. In operation, the fiber grating 72 functions as a negative fiber grating for light energy entering from the left and as a positive fiber grating for light energy entering from the right.

For example, a short wavelength optical pulse exiting the right side of the gain/modulator 80 is collimated by the lens 90a, reflected by the two reflectors 4a, 4b, and focused by the lens 90b into the fiber grating 72. From this input direction, the fiber grating 72 functions as a positive fiber grating, and the short wavelength pulse is reflected by the right side of the fiber grating 72. The pulse then returns to the gain/modulator 80 and is passed to the lens 90c that collimates the pulse. The pulse then passes through the path length adjuster 178, discussed below, is reflected by the reflectors 4c, 4d, and is focused by the lens 90d into the fiber grating 72. From this direction the fiber grating 72 functions as a negative fiber grating, and the short wavelength pulse is again reflected by the right side of the fiber grating 72 and returns to the gain/modulator 80.

As in the laser systems 68 and 68a, an asymmetry exists in the configuration of the laser system 68b. In particular, the roundtrip optical path taken by a shortest wavelength optical pulse that exits the right of the gain/modulator 80, is reflected by the right side of the fiber grating 72 and returns to the gain/modulator 80 is at least as long as the roundtrip optical path taken by the same optical pulse that exits the left of the gain/modulator 80, is reflected by the right side of the fiber grating 72, and returns to the gain/modulator 80. Given this asymmetry, the selection of a particular wavelength by the laser system 68b is achieved by manipulating the sequence of drive signals from the drive signal generator 86, as described with respect to FIG. 8.

The path length adjuster 178 is a plate of transparent optical material (e.g., an optical glass with antireflection coating on each surface) inserted in the optical paths to provide a mechanism for adjusting the length of the optical paths. The adjustment is achieved by tilting the path length adjuster 178 so that more or less of the path length adjuster 178 is placed in the optical paths. Due to the different propagation speeds, changing the amount of the path length adjuster 178 in the optical paths changes the roundtrip time of generated optical pulses. This change alters the repetition rate of the laser system 68b and allows, for example, the repetition rate to be calibrated to match the repetition rate of a WDM communication system to which the laser system 68b is coupled. Although shown with respect to the laser system 68b, the path length adjuster 178 can be employed in the other embodiments described.

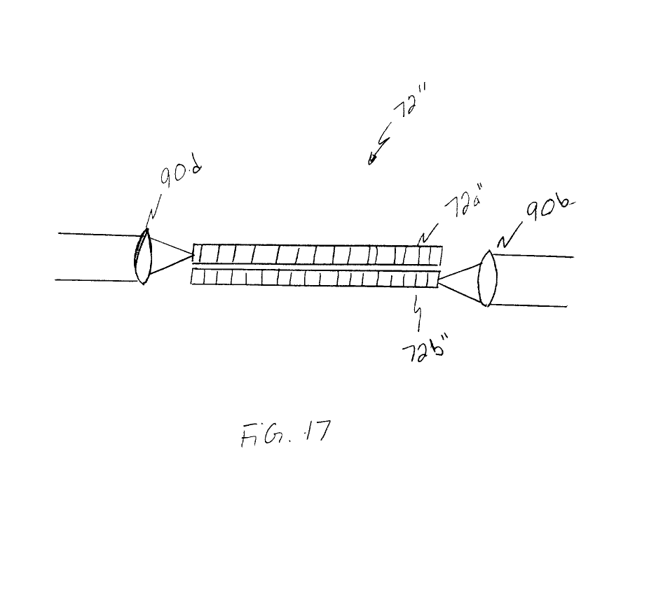

In one embodiment, shown in FIG. 16, the standard chirped fiber grating 72 is replaced with a dual-core chirped fiber grating 72′. The dual-core chirped fiber grating 72′ has two cores 73a, 73b each of which is capable of transmitting optical pulses. The first core 73a is coupled via the lens 90b to optical pulses that exit the right side of the gain/modulator 80. The second core 73b is coupled via the lens 90d to optical pulses that exit the left side of the gain/modulator 80. The fiber grating 72′ is useful because, in some commercially available fiber gratings 72, optical pulses are not completely reflected by the fiber grating 72 and a small percentage of the energy in each optical pulse is transmitted through the fiber grating 72. If energy is transmitted through the fiber grating 72, then the stability of the laser 68 is affected.

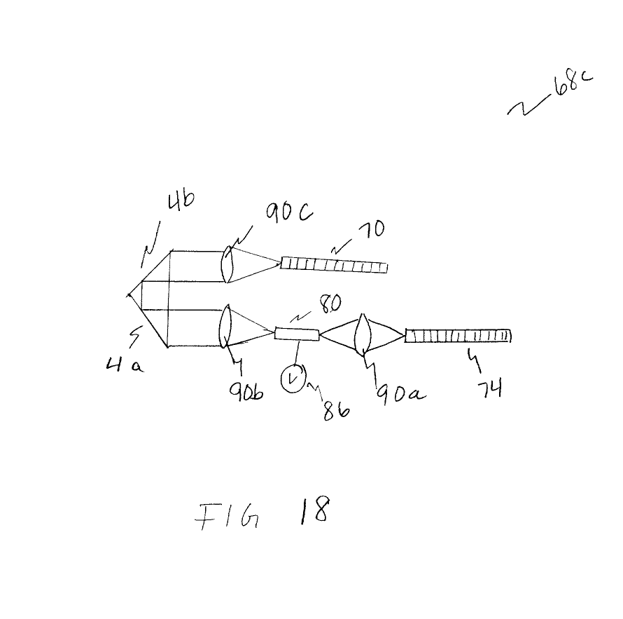

FIG. 17 shows an additional alternative embodiment 72″ for the fiber grating 72. In this embodiment 72″, the single fiber 72 is replaced with two adjacent fibers 72a″, 72b″. The operational benefits for the laser system 68b provided by the two adjacent fibers 72a″, 72b″ is similar to that provided by the dual-core fiber 72′ described above. In one embodiment to ensure that the two fibers share a common grating spacing, the grating structures are created simultaneously, as described above.

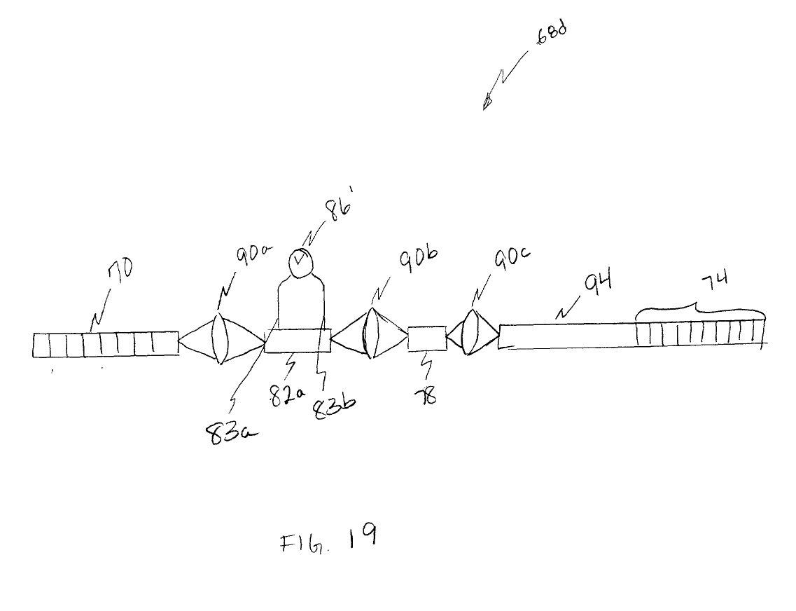

FIG. 18 shows a laser system 68c that is an additional compact alternative embodiment of the present invention. The laser system 68c includes a negative grating 70, a positive grating 74, a gain/modulator 80, a drive signal generator 86, three lenses 90a, 90b, 90c, and two reflectors 4a, 4b. The laser system 68c functions in a fashion similar to that described above with respect to the laser system 68 with the addition that light transmitted to the negative fiber grating 70 is twice reflected. This reflection means that the negative fiber grating 70 can be placed adjacent to the gain/modulator 80 and the positive fiber grating 74 and the entire laser system 68c can be contained in a compact region.

FIG. 19 shows a laser system 68d that is an alternative embodiment of the laser system 68 for use with high modulation frequencies, for example, modulation frequencies exceeding 1 GHz. The traveling wave modulator 82a replaces the optical modulator 82 of FIG. 6. As light pulses in the laser system 68d travel in both directions alternatively, the drive signal generator 86 generates a bipolar drive signal that is applied to the modulator terminals 83a, 83b alternatively to drive the traveling wave modulator 82.

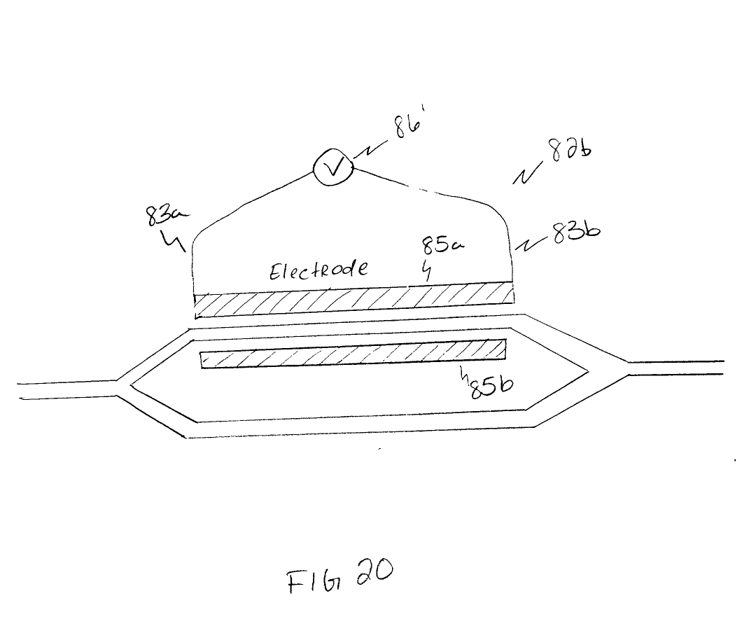

A Mach-Zehnder (MZ) type optical modulator 82b used as the traveling wave modulator 82a is depicted in FIG. 20. In the MZ modulator 82b, the drive signal generator 86 is connected to two ends of an electrode 85a by signal connectors 83a, 83b. Opposite the electrode 85a is, optionally, a ground 85b. In standard MZ modulators 82b, a bipolar drive signal is generated by the drive signal generator 86′ and is applied across electrode 85a. For example, for a pulse traveling to the right, the drive signal enters the electrode 85a through the signal connector 83a, travels down the electrode to the right, exits the electrode 85a through the signal connector 83b, and then is absorbed by either the signal generator 86′ or by the connector 83b. In operation as pulses alternate transmission direction through the MZ modulator 82b, the drive signal is fed into the electrode 85a in an alternating fashion by the signal connectors 83a and 83b.

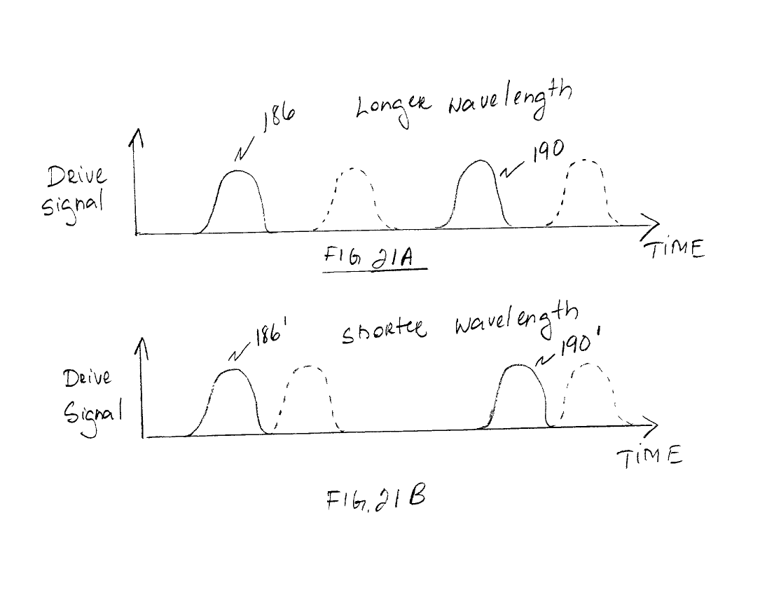

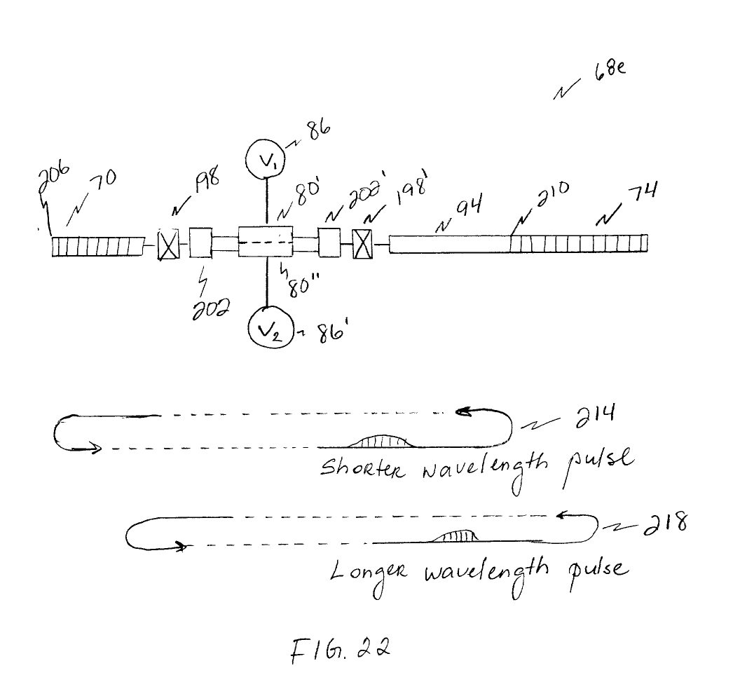

The drive signal applied to the traveling wave modulator 82a is illustrated in FIGS. 21A and 21B. The drive signal represented by a solid line enters the traveling wave modulator 82a through the signal connector 83a and the drive signal represented by a dashed line enters the traveling wave modulator 82a through the signal connector 83b. The timing diagram shown in FIG. 21A is used to generate a shorter wavelength pulse and the timing diagram shown in FIG. 21B is used to generate a longer wavelength pulse. As above, the round trip time as represented by the time between the first 186, 186′ and third 190, 190′ drive signals is constant. Varying the ratio of the time periods, here the time from a solid signal to a dashed signal and the time from a dashed signal to a solid signal, varies the wavelength of the light pulse generated by the laser system 68d.

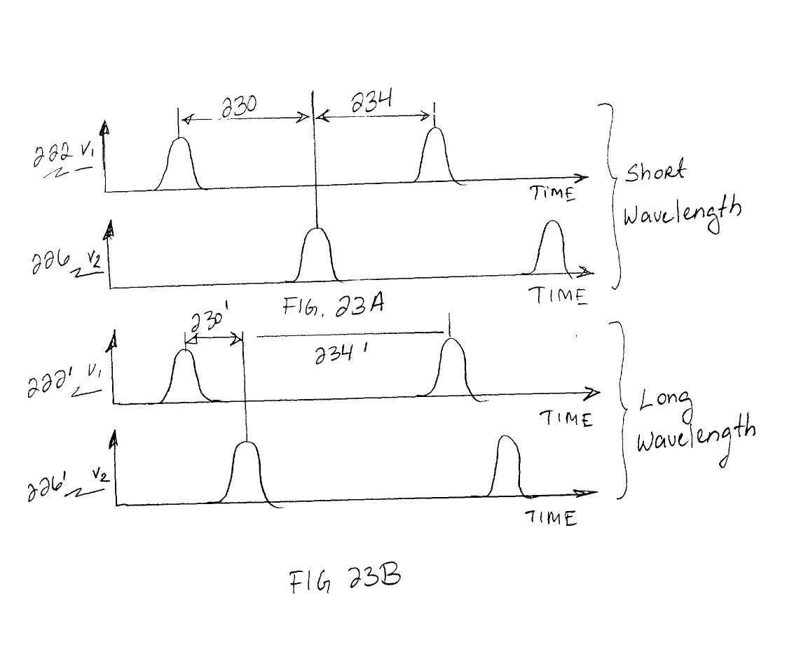

FIG. 22 shows a laser system 68e in which the gain/modulator 80 has separate regions 80′, 80″ for each propagation direction. The laser system 68e includes a negative fiber grating 70, a positive fiber grating 74, two quarter wave plates 198, 198′, two polarization dependent beam directors (e.g., polarizing beam splitters) 202, 202′, a first gain/modulator region 80′, a second gain/modulator region 80″, a first drive signal generator 86, a second drive signal generator 86′, and a fiber offset 94. The specific structure and operation of the polarization dependent beam directors 202, 202′ and the quarter wave plates 198, 198′ are described below in more detail. This configuration combined with the appropriate drive signals ensures that optical pulses travel to the left in the gain/modulator region 80′ and to the right the gain/modulator region 80″. In particular, an optical pulse exiting the first gain/modulator region 80′ passes through the polarization dependent beam director 202 and the quarter wave plate 198, is reflected by the negative fiber grating 70 and passes back through the quarter wave plate 198 and the polarization dependent beam director 202. The optical pulse then travels through the second gain/modulator region 80″, the polarization dependent beam director 202′ and the quarter wave plate 198′, is reflected by the positive fiber grating 74, and passes back through the quarter wave plate 198′ and the polarization dependent beam director 202′ before returning to the first gain/modulator region 80′.

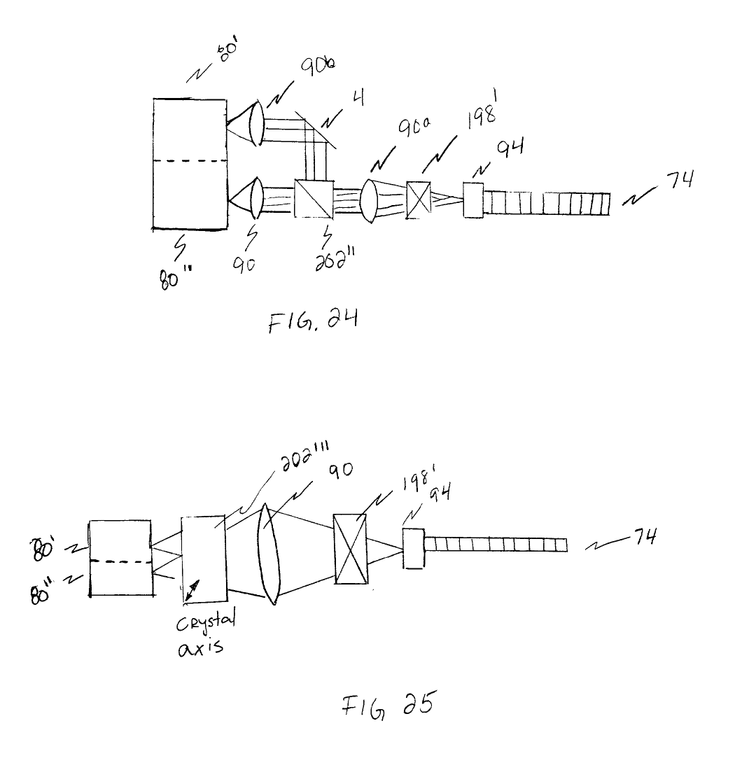

In the laser system 194, the wavelength of an optical pulse is determined by pairs of timing diagrams 222, 226 and 222′, 226′ that are generated by the first and second drive signal generators 86, 86′. The timing pair shown in FIG. 23A is used to generate a short wavelength pulse that propagates as described above. The timing pair shown in FIG. 23B is used to generate a long wavelength pulse that also propagates as described above. As previously indicated, varying the ratio of the return period 230, 230′ to the negative fiber grating 70 from the gain/modulator regions 80′, 80″ to the return period 234, 234′ to the positive fiber grating 74 from the gain/modulator regions 80′, 80″ is used to select a longer or a shorter wavelength pulse.

The propagation direction of an optical pulse in the laser system 68e is determined by the structure of the laser system 68e and by the order of the drive signals from the first and second drive signal generators 86, 86′. With respect to the structure, the asymmetry of the laser system 68e requires that the far end 206 of the negative fiber grating 70 be closer to the gain/modulator regions 80′, 80″ than the near end 210 of the positive fiber grating 74. This condition ensures that the shortest return period 234, 234′ to the positive fiber grating 74, i.e. for the shortest supported wavelength pulse, is greater than one half of the period of the round-trip time. Given this, the return period 234, 234′ to the positive fiber grating 74 is greater than the return period 230, 230′ to the negative fiber grating 70 for all wavelengths. Therefore, for pulses traveling from the gain/modulator region 80″ to the positive fiber grating 74 to the gain/modulator region 80′, the time 230, 230′ between a signal from the first drive signal generator 86 to a signal from the second drive signal generator 86′ is always less than the time 234, 234′ between a signal from the second drive signal generator 86′ to a signal from the first drive signal generator 86. The unique ratio of these time periods is used to generate the pulses that travel from the gain/modulator region 80″ to the positive fiber grating 74 to the gain/modulator region 80′.

Although the discussion above pertains to the structure described in FIG. 22, the positive and negative fiber gratings 74, 70 can be interchanged without changing the operating principles of the invention. This exchange would interchange the selection of the shorted and longest wavelength pulses by the timing profiles 222, 226 and 222′, 226′, respectively.

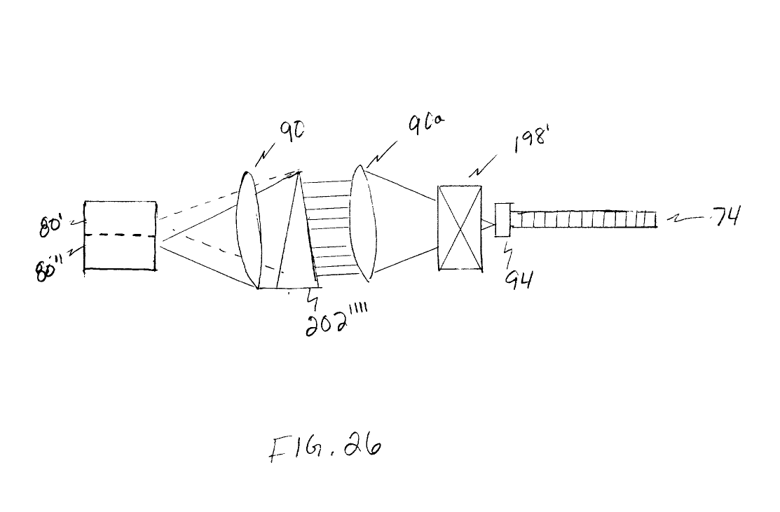

Referring to FIG. 24, the details of one embodiment of the polarization dependent beam director 202′ are shown. In this embodiment, the first gain/modulator region 80′ and the second gain/modulator region 80″ are coupled via three lenses 90, 90a, 90b, a polarizing beam splitter 202″, the quarter wave plate 198′, the fiber offset 94, the positive fiber gratings 74, and a reflector 4. The details of the polarization dependent beam director 202 are directly analogous to the polarization dependent beam director 202′ except that the positive fiber grating 74 is exchanged with a negative fiber grating 70. In operation, optical pulses that exit the gain/modulator region 80″ are polarized. For the purposes of the following illustrative example, these pulses are considered to be vertically polarized. After exiting the gain/modulator region 80″, the pulses are collimated by the lens 90 and passed through the polarizing beam splitter 202″. The collimated pulses are then focused by the lens 90a through the quarter wave plate 198′ and the fiber offset 94 into the positive fiber grating 74. The fast and slow axes of the quarter wave plate 198′ are oriented at 45 degrees to vertical. Therefore, the optical pulses are circularly polarized after exiting the quarter wave plate 198′. These pulses are then reflected by the positive fiber grating 74 back through the fiber offset 94 and the quarter wave plate 198′. Upon exiting the quarter wave plate 198′, the optical pulses are horizontally polarized. These pulses are collimated by the lens 90a and pass to the polarizing beam splitter 202″. The polarizing beam splitter 202″ reflects the horizontally polarized pulses to the reflector 4 that reflects the pulses through the lens 90b into the gain/modulator region 80′. In an alternative embodiment, the quarter-wave plate 198′ is placed between the polarizing bean splitter 202″ and the lens 90a.

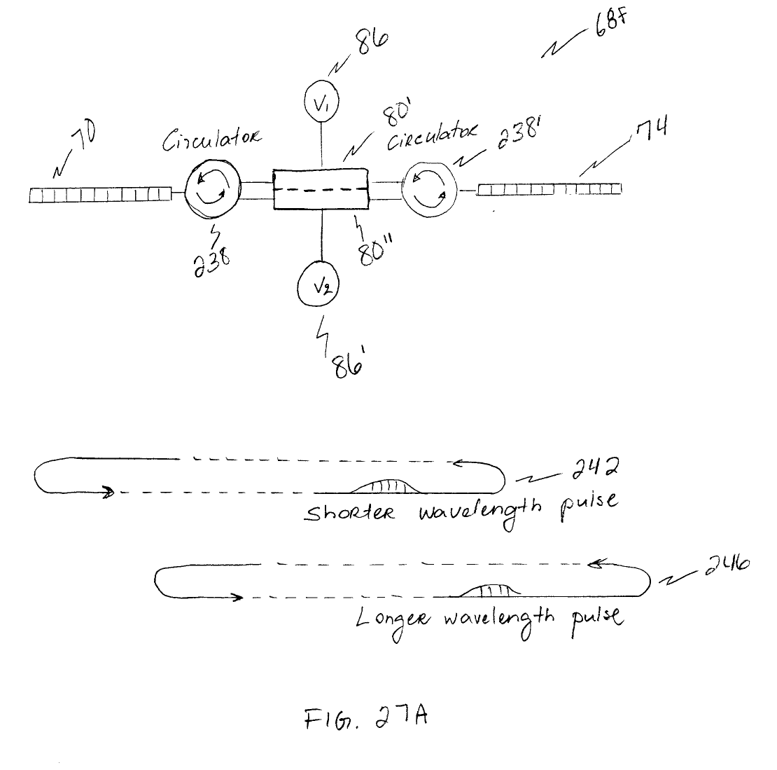

Referring to FIG. 25, the details of another embodiment of the polarization dependent beam director 202′ are shown. In this embodiment, the differential beam steering function is achieved via a birefringent plate 202′″. Optical pulses from the gain/modulator region 80″ pass as the ordinary ray into the birefringent plate 202′″ along a first path. Optical pulses returning from the lens 90, the quarter wave plate 198′, the fiber offset 94, and the positive fiber grating 74 pass along as the extraordinary ray along a second path through the birefringent plate 202′″ into the gain/modulator region 80′. The details of the other polarization dependent beam director 202 are analogous except that the positive fiber grating 74 is exchanged with a negative fiber grating 70. In an alternative embodiment, the quarter-wave plate 198′ is placed between the birefringent crystal plate 202′″ and the lens 90.

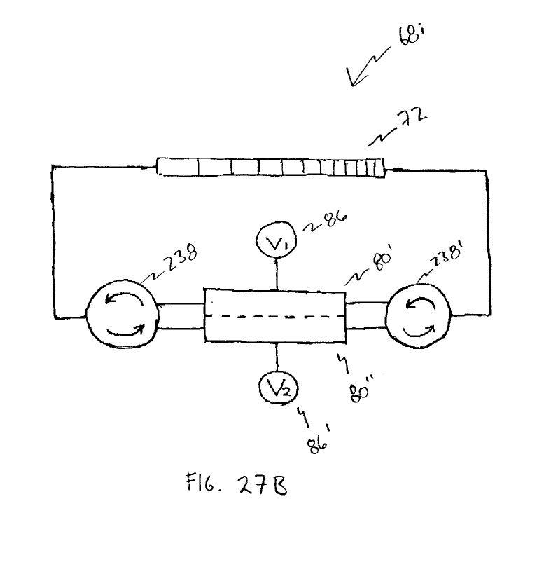

Referring to FIG. 26, the details of a further embodiment of the polarization dependent beam director 202′ are shown. In this embodiment, the differential beam steering function is achieved via a birefringent crystal wedge 202″″ that refracts optical pulses from the gain/modulator region 80″ along a first path and that refracts optical pulses to the gain/modulator region 80′ along a second path. The details of the other polarization dependent beam director 202 are analogous except that the positive fiber grating 74 is exchanged with a negative fiber grating 70.

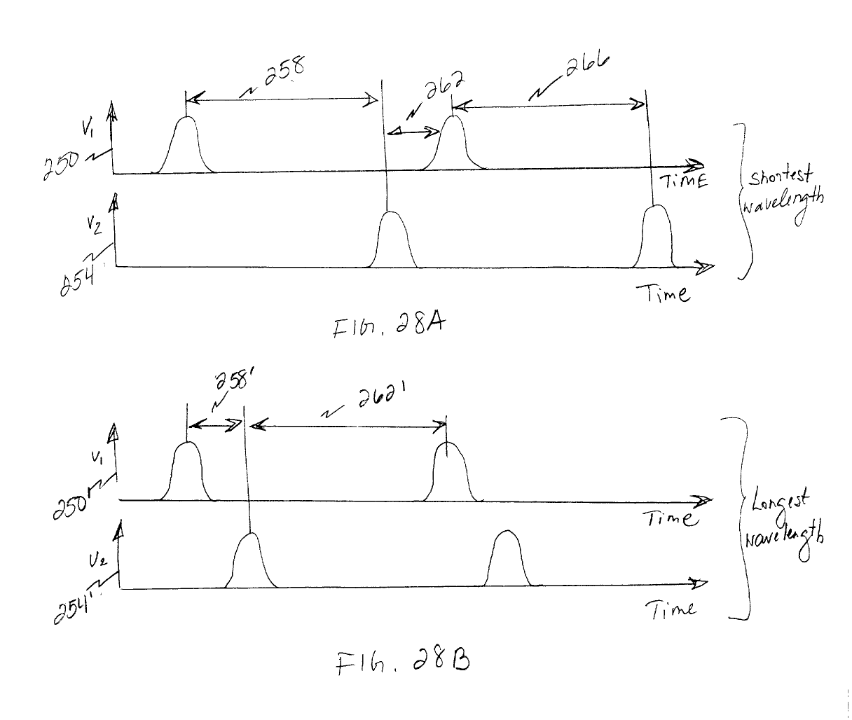

FIG. 27A shows an alternative embodiment 68f of the laser system 68e that includes a gain/modulator region 80′, 80″ for each propagation direction. The laser system 68f includes a negative fiber grating 70, a positive grating 74, two circulators, 238, 238′, a first gain/modulator region 80′, a second gain/modulator region 80″, a first drive signal generator 86, and a second drive signal generator 86′. The specific structure and operation of the circulators 238, 238′ are described below in more detail. In general, this configuration ensures that optical pulses travel to the left in the gain/modulator region 80′ and to the right in the gain/modulator region 80″. This propagation direction limitation means that the negative fiber grating 70 and the positive fiber grating 74 are symmetrically located with respect to the gain/modulator regions 80′, 80″. Consequently, the optical cavity 242 for a shorter wavelength pulse and the optical cavity 246 for a longer wavelength pulse are also symmetrically located with respect to the gain/modulator regions 80′, 80″.

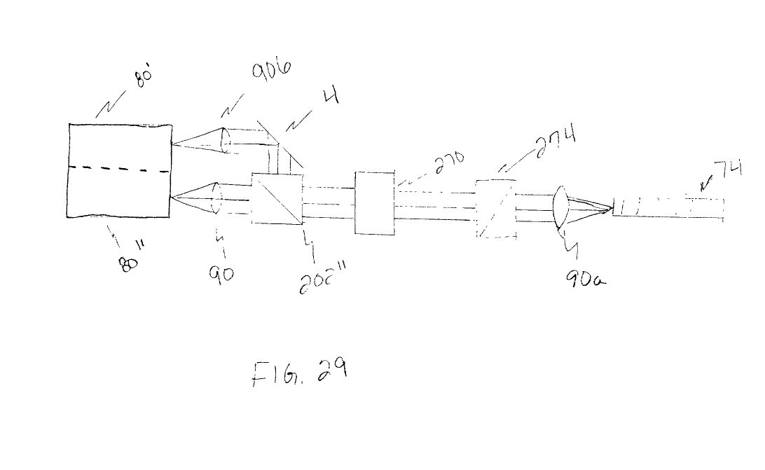

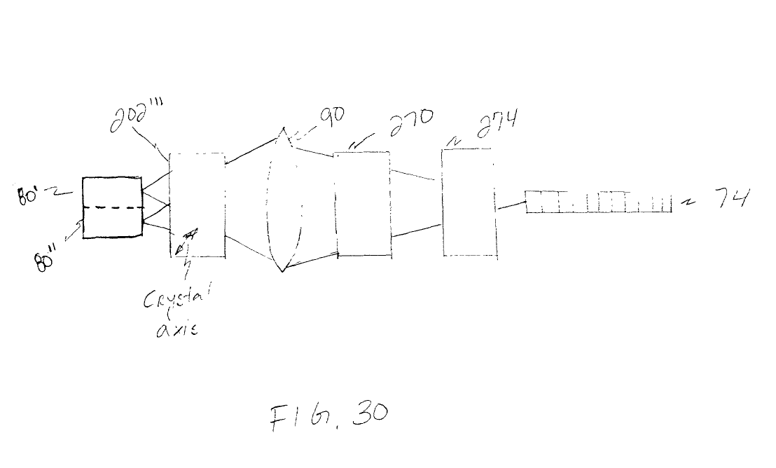

Similar to the operation of the laser system 68e and as shown in FIGS. 28A and 28B, the selection of a pulse of a particular wavelength is based on varying the sequence of drive signals between those for the shortest wavelength pulse 250, 254 and those for the longest wavelength pulse 250′, 254′. Due to the structural symmetry and the propagation direction limitation of the laser system 68f, however, there is no restriction on the ratio of the time 258, 258′ between a signal from the first drive signal generator 86 to a signal from the second drive signal generator 86′ and the time 262, 262′ between a signal from the second drive signal generator 86′ to a signal from the first drive signal generator 86. Even though the time periods 262 and 258′ and 266 and 262′ and their ratios are approximately the same, the timing profiles 250′, 254′ cannot generate a short wavelength pulse because the circulators 238, 238′ prevent pulses from traveling to the right in the gain/modulator region 80′ and the left in the gain/modulator 80″ region.

Referring to FIG. 29, the details of one embodiment of the circulator 238′ are shown. In this embodiment, the first gain/modulator region 80′ and the second gain/modulator region 80″ are coupled together via three lenses 90, 90a, 90b, a polarizing beam splitter 202″, a 45 degree Faraday rotator 270, and a linear polarizer 274, the positive fiber grating 74, and a reflector 4. The details of the other circulator 238 are directly analogous except that the positive fiber grating 74 is exchanged with a negative fiber grating 70. The structure shown in FIG. 29 is similar to the structure shown in FIG. 24 except for the 45-degree Faraday rotator 270 and the polarizer 274. The Faraday rotator 270 and the linear polarizer 274 ensure that optical pulses propagate only to the left in the gain/modulator region 80′ and to the right in the gain/modulator region 80″. For the purposes of illustration consider that the Faraday rotator 270 rotates linearly polarized light in a counter-clockwise direction as defined by the perspective from the polarizing beam splitter 202″ to the positive fiber grating 74 and consider that the polarizer 274 is oriented so that its transmission axis is 45 degrees counter-clockwise from vertical.

As described previously, vertically polarized light generated by the second gain/modulator region 80″ is collimated by the lens 90 and passes through the polarizing beam splitter 202″. The Faraday rotator 270 rotates the plane of polarization by 45 degrees counter-clockwise to vertical. As the linear polarizer 274 is similarly oriented, the pulses pass through the linear polarizer 274 to the positive fiber grating 74. After reflecting from the positive fiber grating 74, the pulses are horizontally polarized by the Faraday rotator 270 and the system subsequently functions as described with respect to FIG. 24.

Pulses can not propagate to the right in the gain/modulator region 80′ and to the left in the gain/modulator region 80″ because they will be removed by the linear polarizer 274. For example, consider horizontally polarized optical pulses exiting the gain/modulator region 80′. These pulses are passed by polarizing beam splitter 202″ to the Faraday rotator 270 that rotates them 45 degrees counter-clockwise from horizontal. As this orientation is perpendicular to the transmission axis of the linear polarizer 274, the pulses are extinguished.

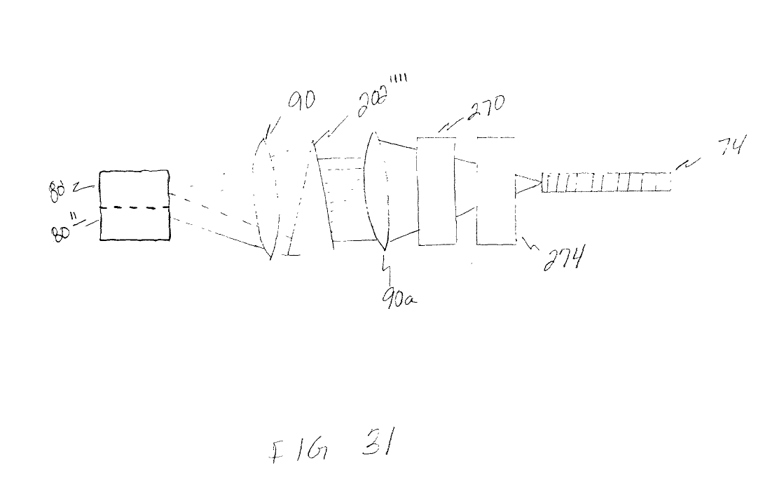

Referring to FIG. 30, the details of a further embodiment of the circulator 238′ are shown. In this embodiment, the first gain/modulator region 80′ and the second gain/modulator region 80″ are coupled together via a birefringent crystal plate 202′″, a lens 90, a 45 degree Faraday rotator 270, a linear polarizer 274, and the positive fiber grating 74. The details of the other circulator 238 are analogous except that the positive fiber grating 74 is exchanged with a negative fiber grating 70. The structure shown in FIG. 30 is similar to the structure shown in FIG. 25 except for the 45-degree Faraday rotator 270 and the polarizer 274. Again, these elements 270, 274 implement the design condition that optical pulses are only permitted to propagate in one direction in the gain/modulator regions 80′, 80″ as described above with respect to FIG. 29.

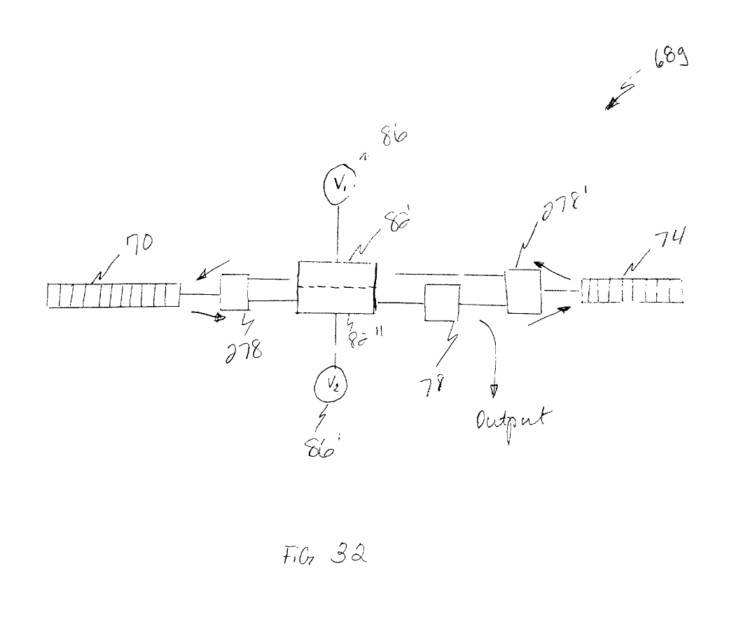

Referring to FIG. 31, the details of another embodiment of the circulator 238′ are shown. In this embodiment, the first gain/modulator region 80′ and the second gain/modulator region 80″ are coupled together via lenses 90, 90a, a birefringent crystal wedge 202″″, a 45 degree Faraday rotator 270, a polarizer 274, and the positive fiber grating 74. The details of the other circulator 238 are analogous except that the positive fiber grating 74 is exchanged with a negative fiber grating 70. The structure shown in FIG. 31 is similar to the structure shown in FIG. 26 except for the 45-degree Faraday rotator 270 and the polarizer 274. These elements 270, 274 implement the design condition that optical pulses are only permitted to propagate in one direction in the gain/modulator regions 80′, 80″, as described above with respect to FIG. 29.

FIG. 27B shows a laser system 68i that is analogous to the laser systems 68b and 68f that is compact in design and has high stability. In the laser system 68i, the negative fiber grating 70 and the positive fiber grating 74 are combined into a single fiber grating 72. The laser system 68i also includes two circulators, 238, 238′, a first gain/modulator region 80′, a second gain/modulator region 80″, a first drive signal generator 86, and a second drive signal generator 86′. As described with respect to FIG. 15, the fiber grating 72 functions as a negative fiber grating for light energy entering from the left and as a positive fiber grating for light energy entering from the right. Those skilled in the art will recognize that the orientation of the fiber grating 72 can be reversed without changing the operating principles of the invention.

The circulators 238, 238′ ensure that light entering the fiber grating 72 from the circulator 238 has a different polarization than light entering the fiber grating 72 from the circulator 238′. This means that even where optical pulses are not completely reflected by the fiber grating 72, that is, where a small percentage of the energy is transmitted through the fiber grating 72, the stability of the laser system 68i is not affected.

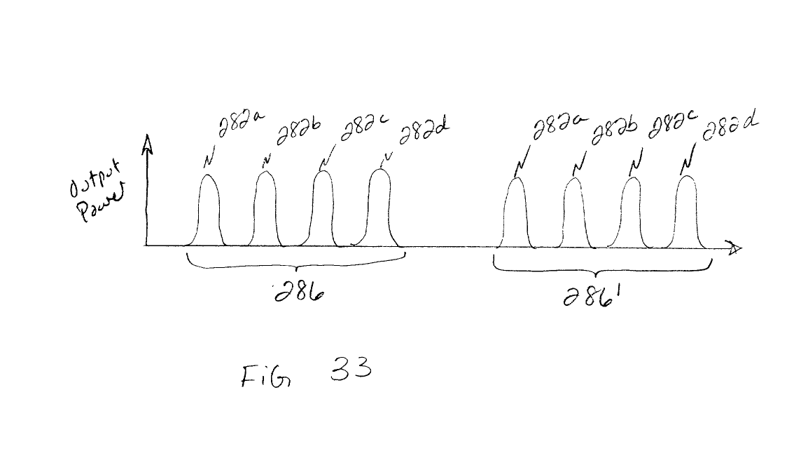

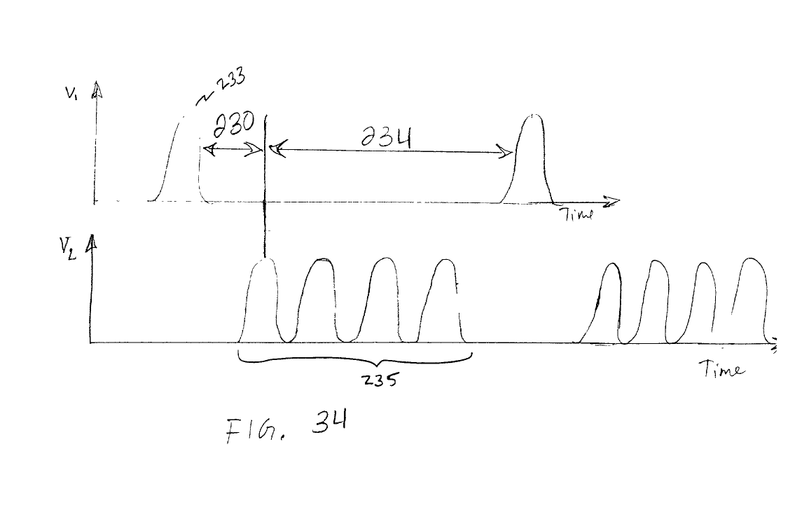

FIG. 32 shows a laser system 68g that simultaneously generates a plurality of optical pulses 282a, 282b, 282c, 282d of different wavelengths. The pulse trains 286, 286′ output from the laser system 68g are shown in FIG. 33. The pulses 282a, 282b, 282c, 282d in the pulse trains 286 or 286′ occur at a repetition rate of between 1 GHz and 100 GHz. The repetition rate, inversely proportional to the time between respective pulses, of the laser system 68g is in the range of 100 MHz to 10 GHz. When no separation occurs between the pulse trains 286 and 286′, then the modulation rate of an external modulator of a WDM system attached to the laser system 68g is the same as the repetition rate of the pulses in the pulse trains 286, 286′, e.g., from 1 GHz to 100 GHz.

The laser system 68g includes a positive fiber grating 74, a negative fiber grating 70, two modulator regions 82′, 82″, two drive signal generators 86, 86′, a gain element 78, and two directional control units 278, 278′. In one embodiment of the laser system 68g, the modulator regions 82′, 82″ have traveling wave designs 82a. Depending on the sequence of drive signals, the directional control units 278, 278′ can be any of the embodiments described in FIGS. 24-26 and FIGS. 29-31. In operation, the drive signal generator 86, produces a sequence of drive signals as shown in the upper portion of FIG. 34. As previously described, these drive signals make the modulator region 82′ transparent and allow optical pulses propagating in the laser system 68g at the proper repetition rate to pass. The optical pulses selected by the modulator region 82′ include all of the wavelengths generated by the gain element 78. From this continuous set of wavelengths, a smaller discrete set of wavelengths is selected by the sequence of drive signals 235 from the drive signal generator 86′, shown in lower portion of FIG. 34. Based on these drive signals, the modulator region 82″ extinguishes from the laser system 68g all of the optical pulses enabled by the drive pulse 233 except those that pass through the modulator region 82′ at the time of the drive signals 235. Due to the wavelength dependent offset in the optical cavities, the enabled set of optical pulses 282a, 282b, 282c, 282d is distributed in a discrete manner over a discrete set of wavelengths.

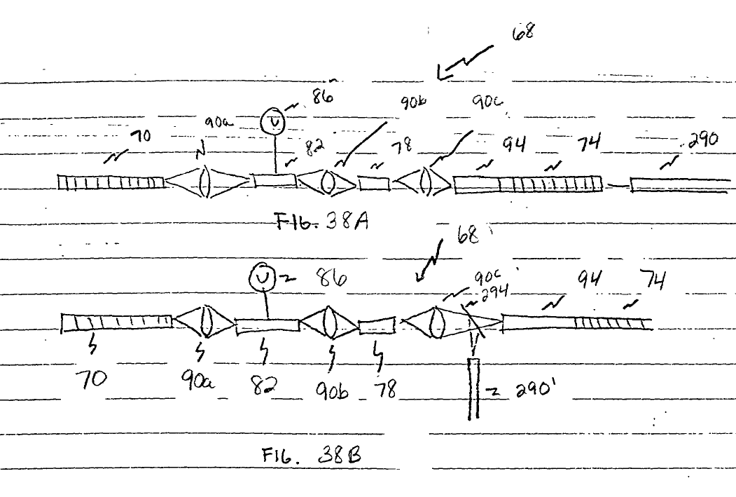

When the drive signal period 234 is larger than the drive signal period 230, the directional control units 278, 278′ can be any of those described in FIGS. 24-26 and 29-31. As described above, only optical pulses that travel through the modulator region 82″ to the right and through the modulator region 82′ to the left are supported by the laser system 68g. When the drive signal period 234 is smaller than the drive signal period 230, the directional control units 278, 278′ can be any of those described in FIGS. 29-31. In this case, the direction of propagation of optical pulses in the laser system 68g is controlled by the circulators 238, 238′. As shown in FIG. 32, optical power is extracted from the laser system 68g after the gain element 82. In an alternative embodiment, the optical power is extracted just before modulator region 82″. The details of the mechanisms used in extracting optical power are described below with respect to FIGS. 38A and 38B.

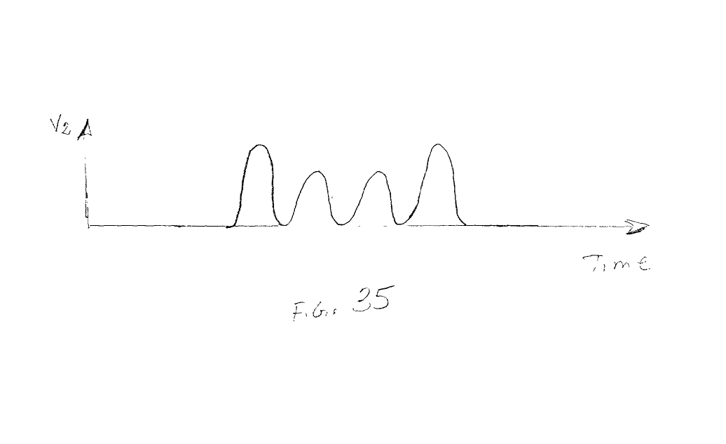

FIG. 35 shows a series of drive signals generated by the drive signal generator 86′ in an alternative embodiment. The drive signals in FIG. 35 have non-uniform amplitude to correct the non-uniform response of many commercially available gain elements 78. The precise shape of the drive signals depends on the specific response of the gain element 78.

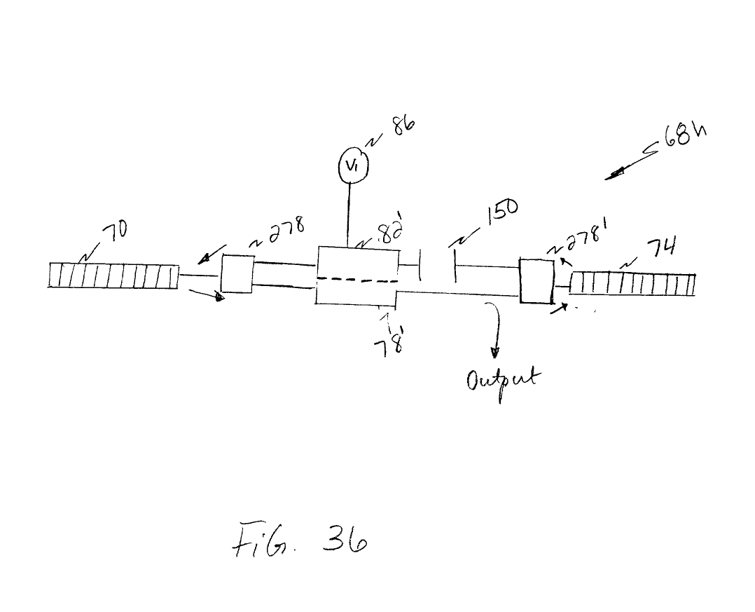

FIG. 36 shows an alternative embodiment 68h of the laser system 68g that also simultaneously generates a plurality of optical pulses 282a, 282b, 282c, 282d of different wavelengths. The laser system 68g includes a positive fiber grating 74, a negative fiber grating 70, a modulator region 82′, a drive signal generator 86, a gain element region 78′, a Fabry-Perot filter 150 (although shown adjacent to the modulator 82, the Fabry-Perot filter 150 can be placed at any location in the optical paths) and two directional control units 278, 278′. The directional control units 278, 278′ can be any of the embodiments described in FIGS. 29-31. In an alternative embodiment (not shown) including a fiber offset 94 for asymmetry, the directional control units can additionally be any of the embodiments described in FIGS. 24-26.

In operation, the drive signal generator 86, produces a sequence of drive signals as shown in the upper portion of FIG. 34. From the continuous set of wavelengths selected by these drive signals, a smaller discrete set of wavelengths is selected by the Fabry-Perot filter 150. As described above, the Fabry-Perot filter 150 transmits only optical pulses whose wavelengths are equal to twice the distance between the reflective surfaces 154, 154′ divided by an integer. To ensure proper operation, the free spectral range of the Fabry-Perot filter 150 is adjusted to the wavelength channel spacing of a resident WDM system. As shown in FIG. 36, optical power is extracted from the laser system 68g after the gain element 78. In an alternative embodiment, the optical power is extracted just before gain element 78.

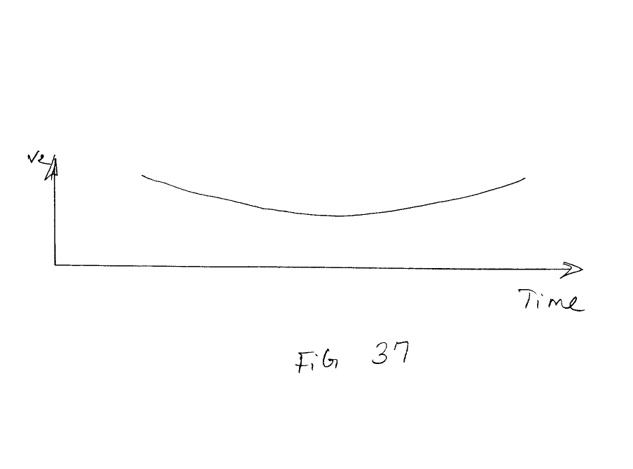

In an additional alternative embodiment of the laser system 68h, a second modulator region is added and driven by the slowly varying waveform shown in FIG. 37. This waveform is used to correct the non-uniform nature of many commercially available gain elements 78. The precise non-uniform nature of the waveform depends on the specific non-uniform properties of the gain element 78.

FIGS. 38A and 38B show two embodiments for extracting optical pulses from the laser system 68. Although shown with respect to the laser system 68, these embodiments can be applied to any of the laser systems 68, 68a, 68b, 68c, 68d, 68e, 68f, 68g, 68h, 68i, (generally 68) described above. Referring to FIG. 38A, optical pulses exit the laser system 68 by passing through the end of the positive fiber grating 74. The transmission of a small percentage (e.g., one to thirty percent (1%-30%)) of the energy of each optical pulses resonating in the laser cavity typically occurs. An output fiber 290 placed adjacent to the end of the positive fiber grating 74 receives the exiting optical pulses. Although the output fiber 290 is shown adjacent to the positive fiber grating 74, it could be placed adjacent to the negative fiber grating 70. In an alternative embodiment, the output fiber 290 and the positive 74 or negative 70 fiber grating are integrated in a single fiber. Referring to FIG. 38B, the laser system 68 is modified to extract the optical pulses using a low reflectivity mirror 294 and an output fiber 290′. In this embodiment, the low reflectivity mirror 294 reflects approximately one to thirty percent (1%-30%) of the energy in each incident optical pulse to the output fiber 290′. The remaining energy is transmitted through the mirror 294 to the fiber offset 94 and the positive fiber grating 74.

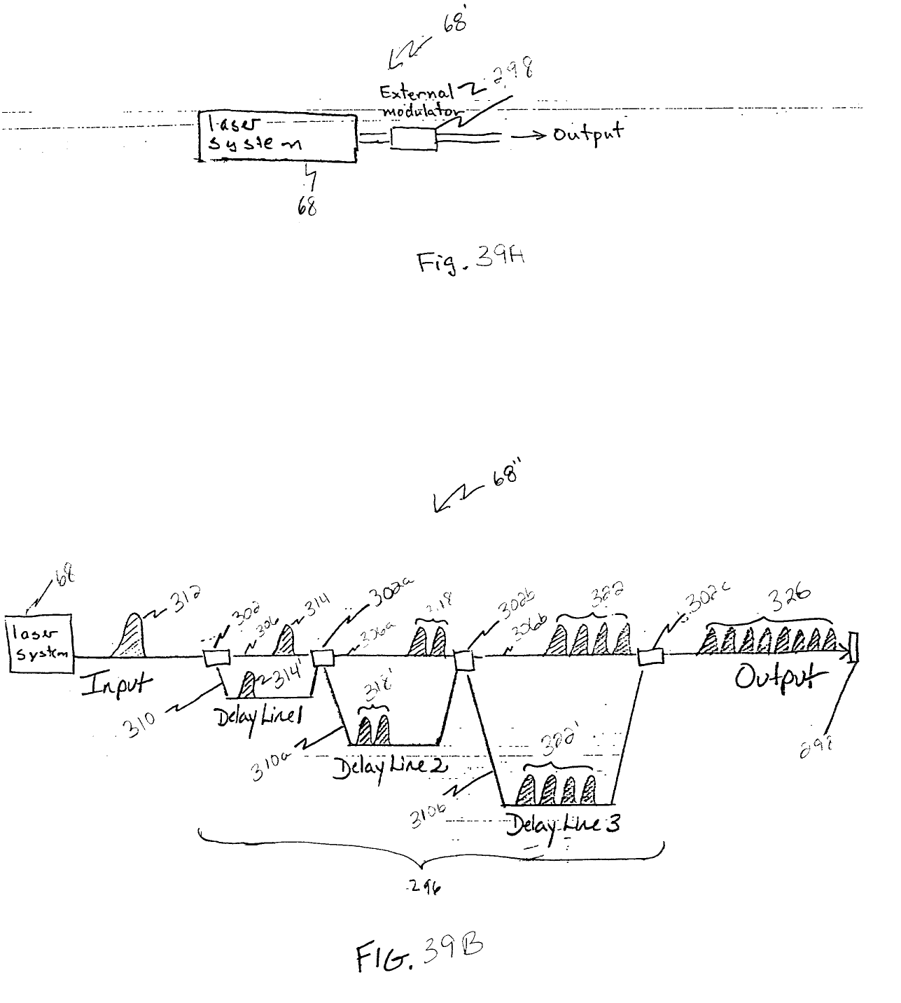

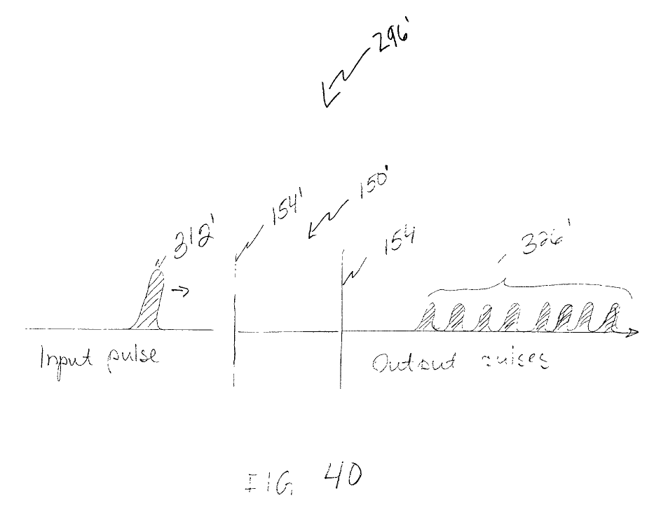

Shown in FIG. 39A is an expanded laser system 68′ that includes as a subsystem one of the laser systems 68. The expanded laser system 68′ includes an external modulator 298 optically coupled to one of the laser systems 68. The external modulator 298 facilitates the use of the expanded laser system 68′ in WDM systems by modulating optical pulse trains that exit the laser systems 68. If the bit rate of the WDM system is higher than the repetition rate of the laser system 68 then each exiting pulse is split into multiple pulses using the delay line system 296, as shown in FIG. 39B, as part of the expanded laser system 68″. The delay line system 296 is interposed between one of the laser systems 68 and the external modulator 298. The structure of the delay line system 296 includes four half power (i.e., “50/50”) beam couplers 302, 302a 302b, 302c. These elements 302, 302a 302b, 302c (generally 302) are optically connected by a first connection line 306, a first delay line 310, a second connection line 306a, a second delay line 310a, and a third connection line 306b, and a third delay line 310b. The delay lines 310, 310a, 310b are longer than their respective connection lines 306, 306a, 306b by a predetermined amount so that when the beams of optical pulses are recombined by the half power beam couplers 302a and 302c, the resulting pulse trains 318, 318′, 322, 322′, 326 have pulses that are evenly spaced in time.

In operation, a pulse 312 exiting the laser system 68 is split by the half power beam coupler 302 into two pulses 314, 314′ each having one half of the energy of the original pulse 312. Each of these pulses 314, 314′ is provided to an input of the half power beam coupler 302a which generates two pairs of pulses 318, 318′ that are transmitted along the second connection line 306a and the second delay line 310a, respectively. The two pairs of pulses 318, 318′ are then provided to the half power beam coupler 302b that generates two sets of four equally spaced pulses 322, 322′. The sum of the energy in these two sets of pulses 322, 322′ is approximately equal to the energy of the original pulse 312. Pulses 322, 322′ are provided to the half power beam coupler 302c that generates two sets of eight equally spaced pulses. One set of eight pulses 326 is shown and is provided to the external modulator 298. The other set (not shown) is either discarded or provided to another external modulator.

In general, the delay line system 296 operates at either a fifty percent (50%) or a one hundred percent (100%) efficiency, depending whether the second final set of pulses is discarded or used by a second external modulator. Although shown to generate eight pulses 326, the delay line system 296 can be scaled to generate a larger or smaller final pulse set by adding or removing beam couplers 302 as needed. As mentioned above, the number of pulses required in a particular final set is generally dependent on the ratio between the WDM bit rate and the laser system pulse repetition rate.

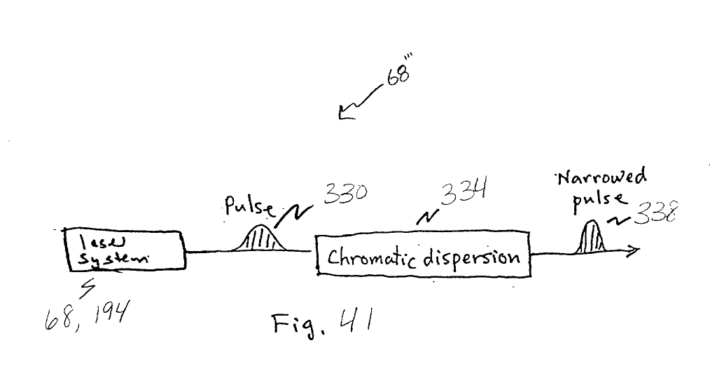

FIG. 40 shows an alternative embodiment 296′ for generating multiple pulses from a single pulse. The alternative embodiment 296′ employs an external Fabry-Perot filter 150′. As above, the multiple pulse generating system 296′ is placed between the laser system 68 and the external modulator 298. The distance between the reflective surfaces 154, 154′ in the Fabry-Perot filter 150′ is selected so that the roundtrip time between the reflective surfaces 154, 154′ matches the signal bit rate of the external modulator 298. In this way a single original pulse 312′ is converted into a pulse train 326′ whose pulses have a spacing that corresponds to the bit rate of the external modulator.

Due to chromatic dispersion in the laser cavity and/or the output path (e.g. the output fiber 290, 290′), pulses generated by the laser systems 68 described above can be temporally broadened, as part of the expanded laser system 68′″. To compensate for this effect, the broadened pulses 330 are provided to a separate compensating pulse narrowing dispersion element 334, as shown in FIG. 41. After passing through dispersion element 334, the pulses 338 are temporally compressed.

Having described and shown the preferred embodiments of the invention, it will now become apparent to one of skill in the art that other embodiments incorporating the concepts may be used and that many variations are possible which will still be within the scope and spirit of the claimed invention. For example as mentioned above, the direction of proposition of optical pulses in the laser systems 68e, 68f, 68g, 68h could be reversed in alternative embodiments. In addition the location of positive and negative fiber grating, positive and negative step fiber grating, and positive and negative diffraction grating/mirror array systems could be interchanged in accordance with the invention. These embodiments should not be limited to disclosed embodiments but rather should be limited only by the spirit and scope of the following claims.

What is claimed is:

1. A wavelength tunable laser system comprising:
(a) a first optical path at a first wavelength having a first path length;
(b) a second optical path at a second wavelength having a second path length substantially equal to said first path length, said second optical path overlapping said first optical path in a shared path, said shared path having an optical path length less than said first path length; and
(c) an optical modulator disposed in said shared path.

2. The system according to claim 1 further comprising a drive signal generator in electrical communication with said optical modulator, wherein a wavelength of an optical pulse is selected by said modulator in response to a sequence of drive signals from said drive signal generator.

3. The system according to claim 2 wherein said wavelength is selected in response to a period of said sequence of drive signals.

4. The system according to claim 1 further comprising a gain element disposed in said shared path.

5. The system according to claim 1 wherein said optical modulator is a gain modulator element.

6. The system according to claim 1 wherein said optical modulator is a traveling wave modulator.

7. The system according to claim 1 further comprising a Fabry-Perot filter disposed in said shared path.

8. The system according to claim 7 wherein said Fabry-Perot filter increases a temporal duration of optical pulses generated by said system.

9. The system according to claim 7 wherein a free spectral range of said Fabry-Perot filter is chosen to match a channel spacing of an attached wavelength division multiplexing system.

10. The system according to claim 1 further comprising a dispersion correction element optically coupled to said first and said second optical paths, said dispersion correction element shorting a temporal duration of optical pulses generated by said system.

11. The system according to claim 1 further comprising a plurality of optical beam couplers optically coupled to said first and said second optical paths, said plurality of optical beam couplers generating a plurality of optical pulses from a single input optical pulse.

12. The system according to claim 1 further including a Fabry-Perot filter optically coupled to said first and said second optical paths, wherein said Fabry-Perot filter generates a plurality of optical pulses from a single input optical pulse.

13. The system according to claim 1 further comprising an external modulator optically coupled to an optical communications network, wherein said external modulator modulates optical pulses onto said optical communications network.

14. A wavelength tunable laser system comprising:
(a) a first fiber grating and a second fiber grating defining a plurality of optical cavities for a plurality of respective wavelengths, each of said plurality of optical cavities overlapping the other of said plurality of optical cavities in a shared path and each of said plurality of optical cavities having a length substantially equal to a first length, said shared path having an optical path length less than said first length; and
(b) an optical modulator disposed in said shared path, said modulator located a second length from said first fiber grating and located a third length from said second fiber grating.

15. The system according to claim 14 wherein said second length is different from said third length.

16. The system according to claim 14 wherein a near end of said first fiber grating is farther from said optical modulator than a far end of said second fiber grating.

17. The system according to claim 14 further comprising a drive signal generator in electrical communication with said optical modulator, wherein a wavelength of an optical pulse is selected by said modulator in response to a sequence of drive signals from said drive signal generator.

18. The system according to claim 17 wherein said wavelength is selected in response to a period of said sequence of drive signals.

19. The system according to claim 14 further comprising a gain element disposed in said shared path.

20. The system according to claim 14 wherein said optical modulator is a gain modulator element.

21. The system according to claim 14 wherein said optical modulator is a traveling wave modulator.

22. The system according to claim 14 further comprising a reflector and wherein said first fiber grating is at least partially adjacent to said second fiber grating.

23. The system according to claim 14 further comprising a Fabry-Perot filter disposed in said shared path.

24. The system of claim 23 wherein said Fabry-Perot filter increases a temporal duration of optical pulses generated by said system.

25. The system according to claim 23 wherein a free spectral range of said Fabry-Perot filter is chosen to match a channel spacing of an attached wavelength division multiplexing system.

26. The system according to claim 14 further comprising a dispersion correction element optically coupled to said plurality of optical cavities, said dispersion correction element shorting the temporal duration of optical pulses generated by said system.

27. The system according to claim 14 further comprising a plurality of optical beam couplers optically coupled to said plurality of optical cavities, said plurality of optical beam couplers generating a plurality of optical pulses from a single input optical pulse.

28. The system according to claim 14 further comprising a Fabry-Perot filter optically coupled to said plurality of optical cavities, wherein said Fabry-Perot filter generates a plurality of optical pulses from a single input optical pulse.

29. The system according to claim 14 further comprising an external modulator optically coupled to an optical communications network, wherein said external modulator modulates optical pulses onto said optical communications network.

30. A wavelength tunable laser system comprising:
(a) a first fiber grating and a second fiber grating, at least one of said first and second gratings having a plurality of grating regions, each of said grating regions having a unique grating period, each of said plurality of grating regions defining an optical cavity for a respective wavelength, each of said optical cavities overlapping the other of said optical cavities in a shared path and each of said discrete set of optical cavities having a length substantially equal to a first length, said shared path having an optical path length less than said first length; and
(b) an optical modulator disposed in said shared path, said modulator located a second length from said first fiber grating and located a third length from said second fiber grating.

31. The system according to claim 30 wherein said second length is different from said first length.

32. A wavelength tunable laser system comprising:
(a) a first fiber grating and a second fiber grating defining a plurality of optical paths for a plurality of respective wavelengths, each of said plurality of optical paths overlapping the other of said plurality of optical paths in a first shared path and in a second shared path and each of said plurality of optical paths having a length substantially equal to a first length, said first and said second shared paths having a combined optical path length less than said first length;
(b) a first optical modulator region disposed in said first shared path, said first modulator region located a first distance from said first fiber grating and located a second distance from said second fiber grating, said first distance being different from said second distance; and
(c) a second optical modulator region disposed in said second shared path, said second optical modulator region located a third distance from said first fiber grating and located a fourth distance from said second fiber grating, said third distance being different from said fourth distance.

33. The system according to claim 32 wherein at least one of said first and second fiber gratings is a chirped fiber grating.

34. The system according to claim 32 wherein at least one of said first and second fiber gratings has a plurality of grating regions, each of said grating regions having a unique grating period.

35. The system according to claim 32 wherein said first distance is substantially equal to said third distance and wherein said second distance is substantially equal to said fourth distance.

36. The system according to claim 32 wherein an optical pulse transmitted along one of said plurality of optical paths is constrained to travel from said first optical modulator region to said first fiber grating and from said second optical modulator region to said second fiber grating.

37. The system according to claim 32 further comprising a Fabry-Perot filter disposed in said first shared path.

38. The system according to claim 37 wherein said Fabry-Perot filter increases the temporal duration of optical pulses generated by said system.

39. The system according to claim 37 wherein a free spectral range of said Fabry-Perot filter is chosen to match a channel spacing of an attached wavelength division multiplexing system.

40. The system according to claim 32 further comprising a polarization dependent beam director and a quarter wave plate disposed in said plurality of optical paths.

41. The system according to claim 40 wherein said polarization dependent beam director comprises a polarizing beam splitter.

42. The system according to claim 40 wherein said polarization dependent beam director comprises a birefringent crystal plate

43. The system according to claim 40 wherein said polarization dependent beam director comprises a birefringent crystal wedge.

44. The system according to claim 32 further comprising:
(d) a first drive signal generator in electrical communication with said first optical modulator region; and
(e) a second drive signal generator in electrical communication with said second optical modulator region,
wherein a wavelength of an optical pulse is selected by said first and said second modulator regions in response to a sequence of drive signals from said first and said second drive signal generators.

45. The system according to claim 44 wherein said wavelength is selected in response to a period of said sequence of drive signals.

46. The system according to claim 32 further comprising a first drive signal generator in electrical communication with said first optical modulator region and a second drive signal generator in electrical communication with said second optical modulator region, wherein a series of optical pulses of different wavelengths are generated by said first and said second modulator regions in response to a sequence of drive signals from said first and said second drive signal generators.

47. The system according to claim 46 wherein said sequence of drive signals have non-uniform amplitudes.

48. The system according to claim 32 further comprising a first gain element disposed in said first shared path.

49. The system according to claim 32 wherein said first optical modulator region is a gain modulator element.

50. The system according to claim 32 wherein said first optical modulator region is a traveling wave modulator region.

51. The system according to claim 32 further comprising a circulator disposed in said plurality of optical paths.

52. The system according to claim 51 wherein said circulator comprises a polarizing beam splitter, a faraday rotator, and a polarizer.

53. The system according to claim 51 wherein said circulator comprises a birefringent crystal plate, a faraday rotator, and a polarizer.

54. The system according to claim 51 wherein said circulator comprises a birefringent crystal wedge, a faraday rotator, and a polarizer.

55. The system according to claim 32 wherein a near end of said first fiber grating is farther from said first and second optical modulator regions than a far end of said second fiber grating.

56. The system according to claim 32 further comprising a dispersion correction element optically coupled to said plurality of optical paths, said dispersion correction element shorting the temporal duration of optical pulses generated by said system.

57. The system according to claim 32 further comprising a plurality of optical beam couplers connected to said plurality of optical paths, said plurality of optical beam couplers generating a plurality of optical pulses from a single input optical pulses.

58. The system according to claim 32 further comprising a Fabry-Perot filter optically coupled to said plurality of optical paths, said Fabry-Perot filter generating a plurality of optical pulses from a single input optical pulse.

59. The system according to claim 32 further including an external modulator optically coupled to an optical communications network, wherein said external modulator modulates optical pulses onto said optical communications network.

60. A wavelength tunable laser system comprising:
(a) a first fiber grating and a second fiber grating defining a plurality of optical paths for a plurality of respective wavelengths, each of said plurality of optical paths overlapping the other of said plurality of optical paths in a first shared path and in a second shared path and each of said plurality of optical paths having a length substantially equal to a first length, said first and said second shared paths having a combined optical path length less than said first length;
(b) an optical modulator disposed in said first shared path, said optical modulator located a first distance from said first fiber grating and located a second distance from said second fiber grating, said first distance being different from said second distance;
(c) a gain element disposed in said second shared path, said gain element located a third distance from said first fiber grating and located a fourth distance from said second fiber grating, said third distance being different from said fourth distance;
(d) a Fabry-Perot filter located in said first shared path; and
(e) a drive signal generator in electrical communication with said optical modulator,
wherein a series of optical pulses of different wavelengths are generated by said optical modulator and said Fabry-Perot filter in response to a sequence of drive signals from said drive signal generator.

61. The system according to claim 60 wherein at least one of said first and second fiber gratings is a chirped fiber grating.

62. The system according to claim 60 wherein at least one of said first and second fiber gratings has a plurality of grating regions, each of said grating regions having a unique grating period.
